(19) United States
(12) Patent Application Publication
(10) Pub. No.: US 2008/0201505 A1
(43) Pub. Date: Aug. 21, 2008

(54) Multimedia data collection device for a host with a single available input port

(76) Inventor: David A. Monroe, San Antonio, TX (US)

Correspondence Address: MOORE LANDREY, 1609 SHOAL CREEK BLVD, SUITE 100, AUSTIN, TX, 78701, US

(21) Appl. No.: 10/753,658

(22) Filed: Jan. 8, 2004

Related U.S. Application Data
(60) Provisional application No. 60/438,638, filed on Jan. 8, 2003.

(51) Int. Cl. G06F 13/38

(52) U.S. Cl. 710/65

(57) ABSTRACT

A multimedia input system for a handheld device includes a gateway interface for connecting to the handheld device a plurality of discrete input sources generating a plurality or unique input signals and capable of communicating with the gateway interface. A converter is used for converting the each of the plurality of input signals into a signal format acceptable by the handheld device. The gateway interface may be a hub or a router. The gateway interface is adapted for selectively receiving each of the unique input signals at a single port.

### CROSS-REFERENCE TO RELATED APPLICATION

This application claims the priority of U.S. Provisional Application Ser. No. 60/438,638, filed on Jan. 8, 2003.

### BACKGROUND OF THE INVENTION

1. Field of the Invention

The subject invention is directed to a device for providing collecting a plurality of diverse multimedia inputs and inputting same into a host device through a single port, and is specifically directed to a device permitting a handheld computer or PDA to receive numerous data inputs through a single port such as a USB port or the like.

2. Discussion of the Prior Art

With the increasing acceptance and use of PDA's, handheld computers and similar portable, handheld devices it has become increasingly important to provide the means and methods for permitting input to such devices from a variety of external sources. Typically such devices have very limited input ports and each source must be connected and disconnected as different input sources are required.

For some applications this inconvenience is acceptable. For others, such at inconvenience has prevented expanded use of PDA's. An example of a field of use were such an inconvenience substantially limits the applicability of PDA's is military field applications.

Currently, there is an approach known as “Bluetooth” which attempts to solve the problem of providing multiple source connectivity to handheld devices, is available on COTS PDA and Laptop devices. For the near-term, Bluetooth adapters can be built for radio and sensor devices to allow them to talk to PDA's and Laptops. Ultimately Bluetooth can be integrated directly into the devices, and in fact, will likely be in the next generation of commercial devices such as digital cameras and camcorders.

Bluetooth is attractive because of one simple reason—no unwieldy and failure prone cables would be required.

The disadvantages of Bluetooth are:
Bluetooth is not yet approved for Military use.
There are multiple Security Issues.
Bluetooth may be Jammed.
OCONUS spectrum regulations do not yet universally allow Bluetooth operation. (They likely will.)
Hardware development is required to produce several ‘flavors’ of Bluetooth adapters to provide fully for operation of all sensors and radios with Bluetooth.

Based on the above analysis and clarifications provided by the Government, we have decided to submit a base proposal that implements the Card Configuration approach and an alternate proposal that implements the Multi-Media Hub approach. The Card Configuration approach is described in detail in the following paragraphs.

### SUMMARY OF THE INVENTION

The subject invention is directed to a multimedia input system for a handheld device permitting the handheld device to communicate with a plurality of discrete input sources through a single I/O port such as a PCMCIA card, a USB port or the like. The system of the subject invention may be a separate, external plug-in apparatus or may be an integral, embedded unit. For military or other harsh applications the system may be housed in an environmental hardened casing.

In the broadest sense, the device is a hub or router for collecting a plurality of inputs from a plurality of sources and inputting each of the inputs into a host via a single port. The host may be local or remote. In a local configuration the host is connected directly to the multimedia input system. In a remote configuration, the multimedia system defines an access point that is connected to a gateway such as a radio, Intersect connection, satellite transmission system or the like.

In addition to collecting and sending the plurality of inputs, the system is capable of converting the data. For example, raw video signals may be converted to MPEG prior to transmission from the multimedia system to the host. Encryption and compression of data is also completed at the system, permitting both high security and bandwidth conservation prior to transmission of the data.

One useful application of the multimedia system is the military DRSTA program for battlefield situational awareness wherein forward surveillance is conducted using a handheld PDA and radio transmission to transmit data to a remote intermediate station or base station.

### TECHNICAL APPROACH—BASE PROPOSAL

There are three fundamentally different technical approaches that can be taken to meet the general DRSTA requirements:

1.1 Card Configuration Approach

The requirements for DRSTA dictate supporting a multitude of varying interfaces for sensors and radios. Currently no PDA device can support all of the wide variety of needed interfaces, nor will one ever be a COTS item. The Card Configuration approach utilizes COTS PCMCIA cards to configure a COTS PDA for Hide Site and Surveillance Site functions. The Surveillance Site further has to be configured based on the Video Sensor interface that is required.

The advantage of the Card Configuration approach is that the system can be implemented with available industry cards without hardware development (other than cable and connector packaging) and can be integrated with software development.

The disadvantages of the Card Configuration approach are several:
Dissimilar Sensors, such as Analog Video and Firewire, cannot be supported simultaneously during a deployment.
A multiplicity of configurations is required to accommodate the inventory of dissimilar sensors.
Hide Site and Surveillance Site Configurations for sensors are not the same and can't be interchanged during a mission.
The difficulty of changing from one sensor interface to another is problematic (it is not a field operation).

### 1.2 Multi-Media Hub (MMH) Approach

The MULTI-MEDIA HUB is an intelligent circuit that supports all of the host, radio and sensor interfaces that are not normally found in PDA (and laptop) devices. The circuit also has specialized video and audio processing on board to do high-speed compression.

The advantages of the MMH approach are several:
The MMH provides ALL of the required interfaces on-board simultaneously so all devices are supported in the field.
No swapping or re-configuration is required to support different devices.
The MMH approach allows one configuration for both the Surveillance Site and Hide Site.
Additional Radios can be connected allowing multiple net access.
The MMH has specialized communications, audio and video processing that provide additional performance over other approaches.

The only disadvantage of this approach is that the MMH CCA is still currently under development and requires additional hardware and software development effort to complete.

1.3 Bluetooth Approach

Bluetooth is available on COTS PDA and Laptop devices. For the near-term, Bluetooth adapters can be built for radio and sensor devices to allow them to talk to PDA's and Laptops. Ultimately Bluetooth can be integrated directly into the devices, and in fact, will likely be in the next generation of commercial devices such as digital cameras and camcorders.

Bluetooth is attractive because of one simple reason—no unwieldy and failure prone cables would be required.

The disadvantages of Bluetooth are:
Bluetooth is not yet approved for Military use.
There are multiple Security Issues.
Bluetooth may be Jammed.
OCONUS spectrum regulations do not yet universally allow Bluetooth operation. (They likely will.)
Hardware development is required to produce several ‘flavors’ of Bluetooth adapters to provide fully for operation of all sensors and radios with Bluetooth.

Based on the above analysis and clarifications provided by the Government, we have decided to submit a base proposal that implements the Card Configuration approach and an alternate proposal that implements the Multi-Media Hub approach. The Card Configuration approach is described in detail in the following paragraphs.

2. In-Depth Technical Discussion

This implementation is based on the GFE Rugged PDA (R-PDA) that is manufactured by Talla-Tech that is utilized in the Anny's CHS-2 program. This R-PDA is based on the Compaq iPAQ 3955 commercial PDA.

The R-PDA supports two internal PCMCIA adapter card slots as well as either a USB (Slave) port or Serial UO port. All interfacing to Radios, GPS, and Sensor Devices must be accomplished within the limitations of this platform.

2.1 Card Configuration Approach

The limitations of the platform as set forth above prevent “loading up” of the platform with industry standard interface cards to a degree that would allow support of all modes of operation simultaneously. Because one configuration cannot be made to meet all of the differing requirements, a series of configurations that are mission oriented has been developed.

The Card Configuration approach utilizes insertion of appropriate PCMCIA cards and software into the hosting PDA and Laptop devices to create a mission configuration. Each mission configuration requires a different complement of PCMCIA devices and associated interconnection.

2.1.1 Standard DRSTA R-PDA and PCMCIA Card Configurations

Four basic R-PDA configurations are envisioned to meet the DRSTA requirements:
1) A Hide Site, or Surveillance Site with no Video Sensors
2) A Surveillance Site with Analog Video Sensors
3) A Surveillance Site with USB Video Sensors
4) A Surveillance Site with Firewire (IEEE 1394) Sensors

Each configuration is described in more detail on the following pages.

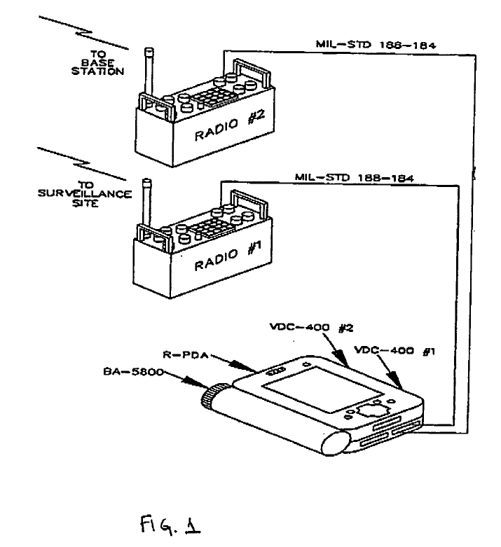

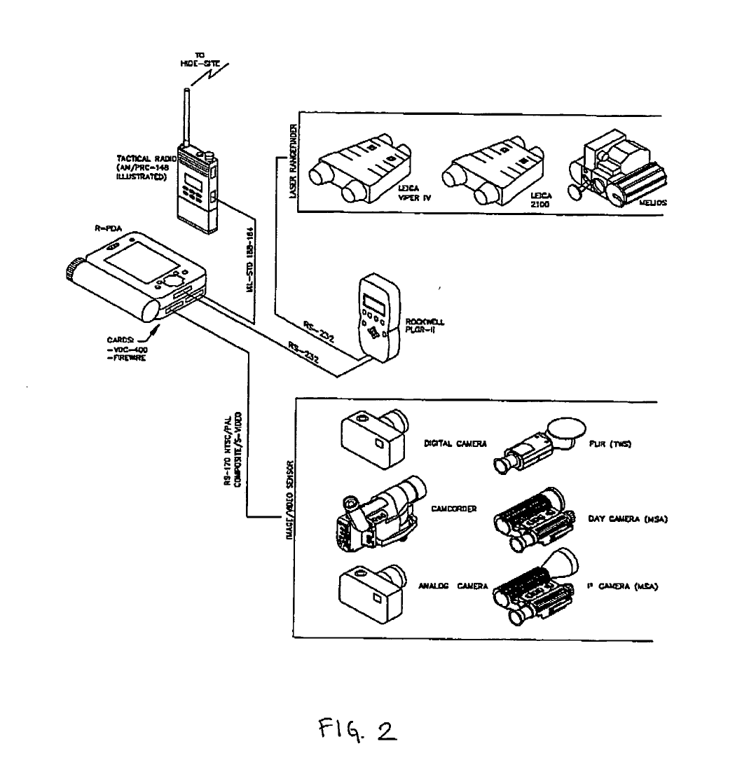

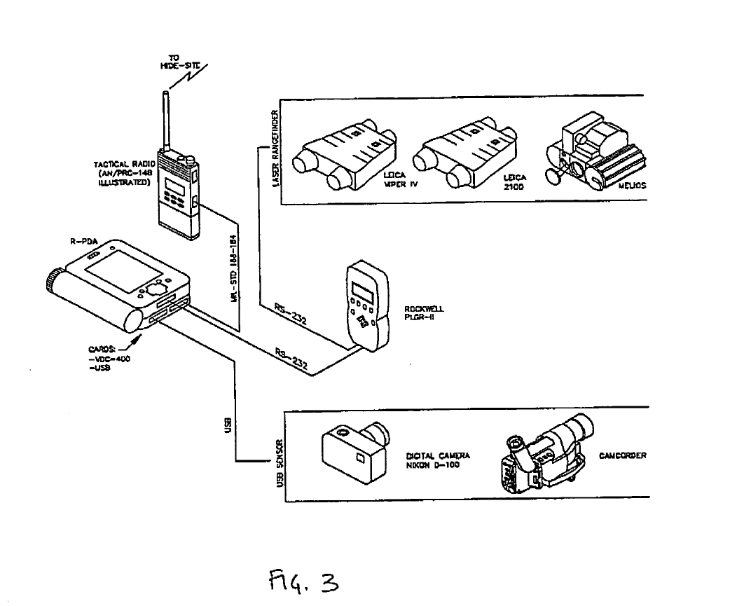

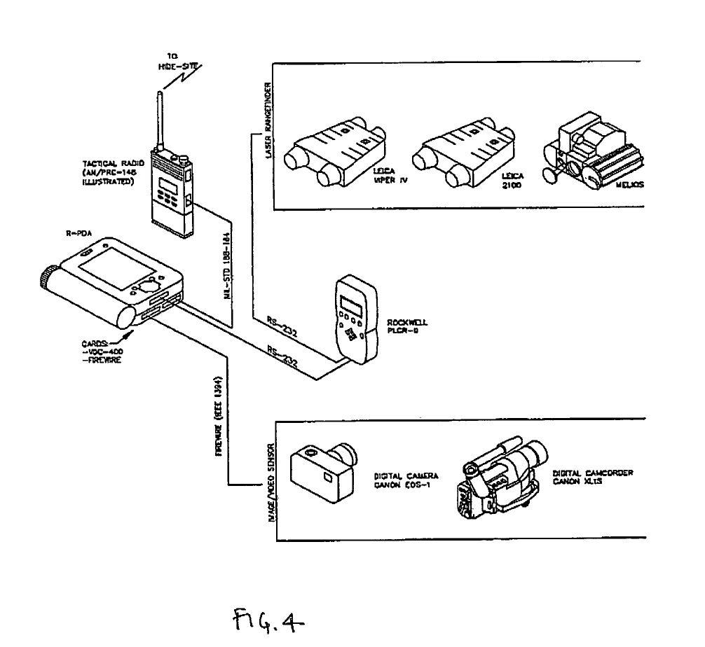

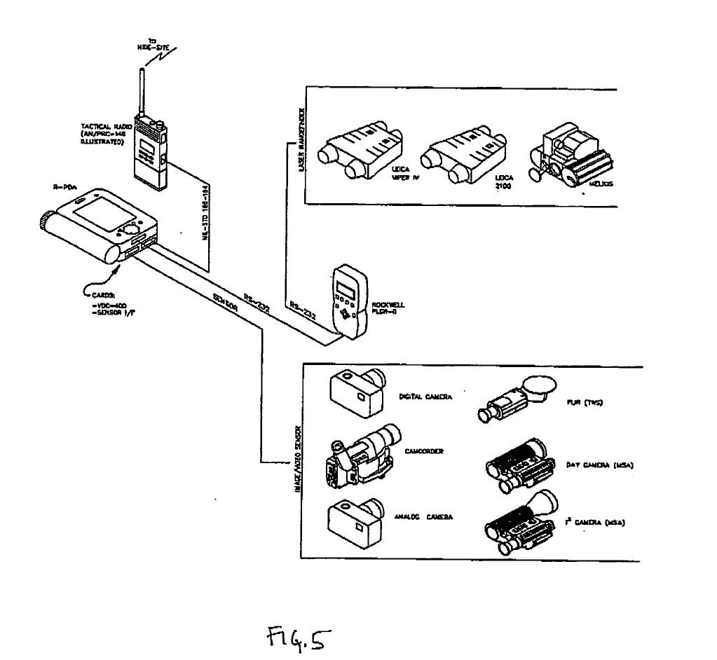

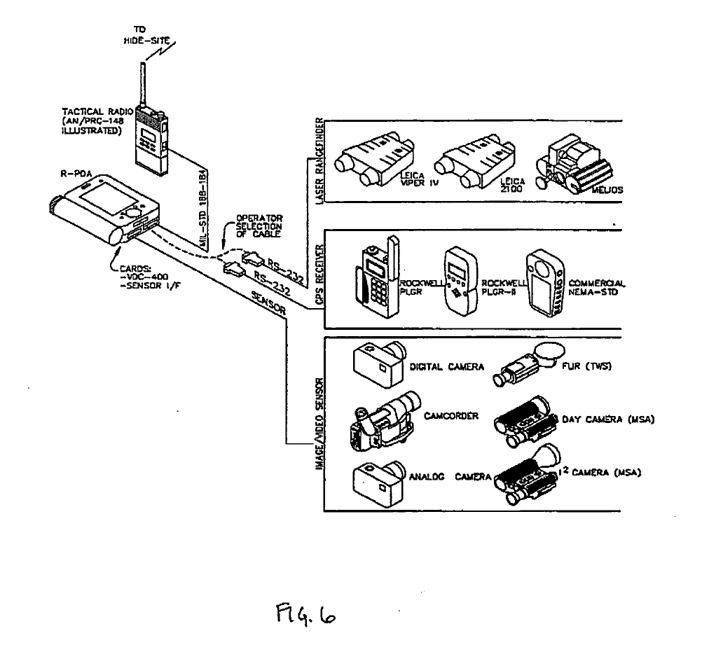

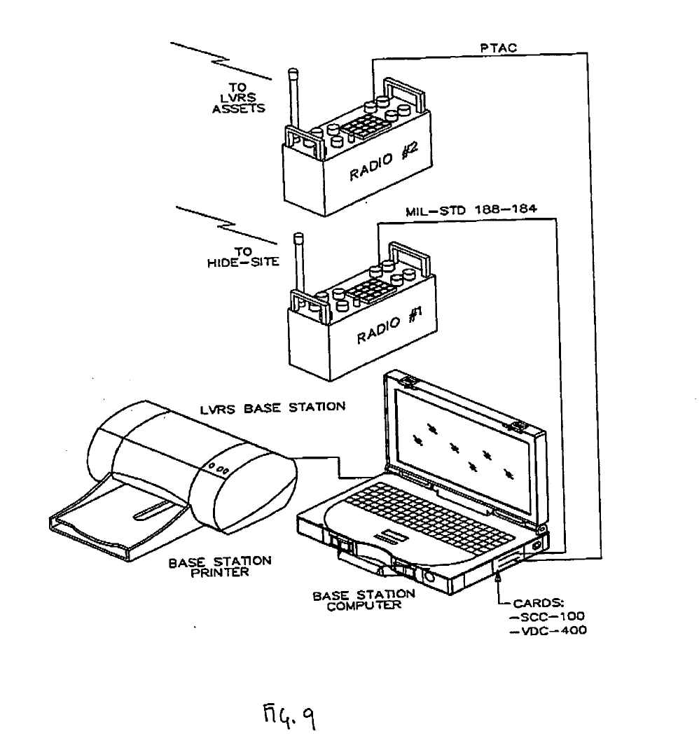

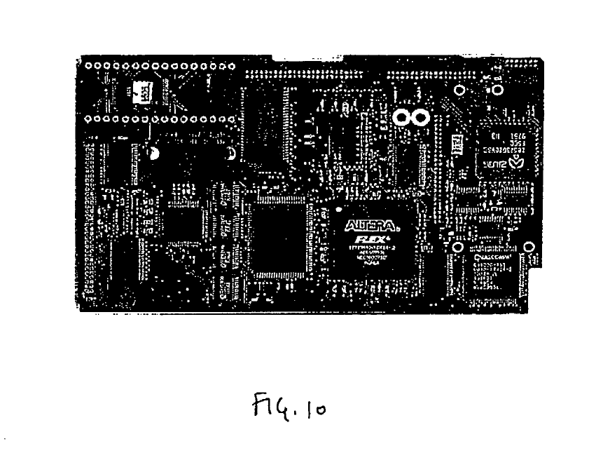

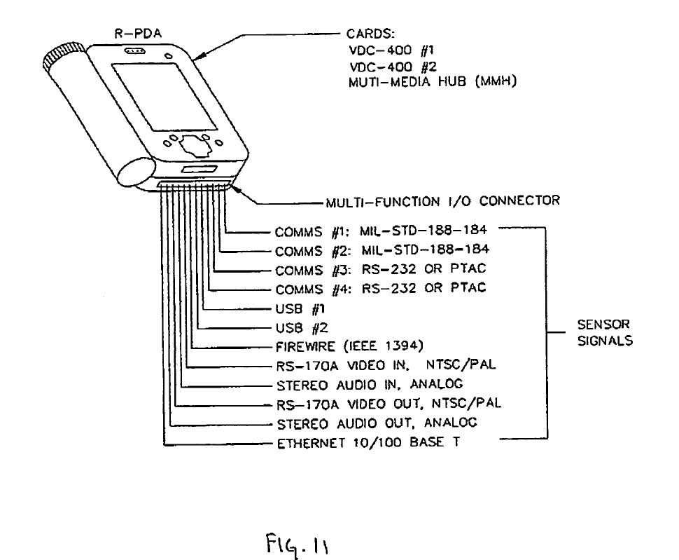

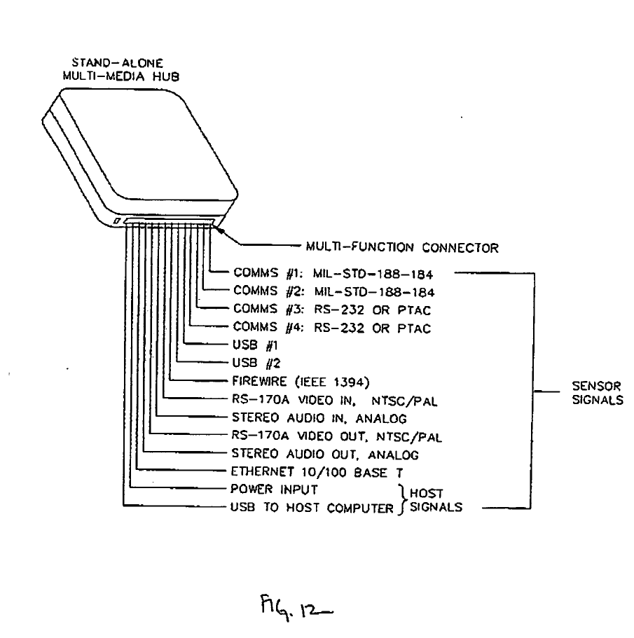

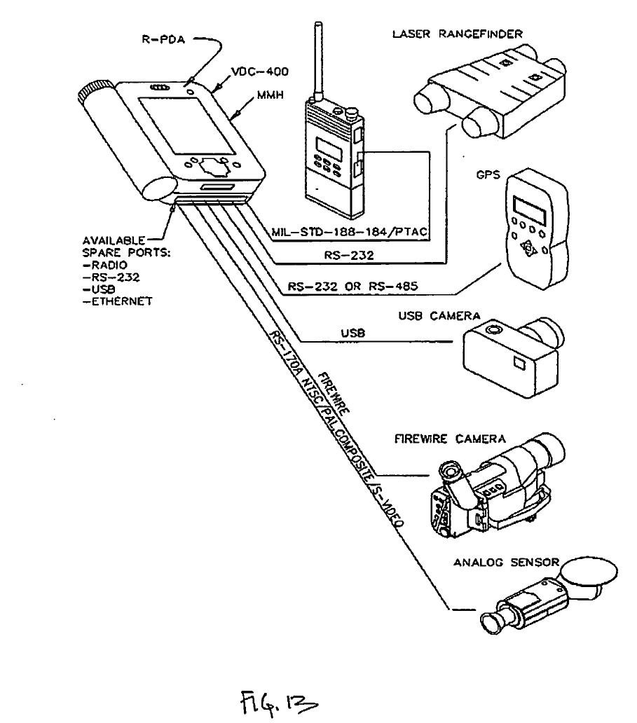

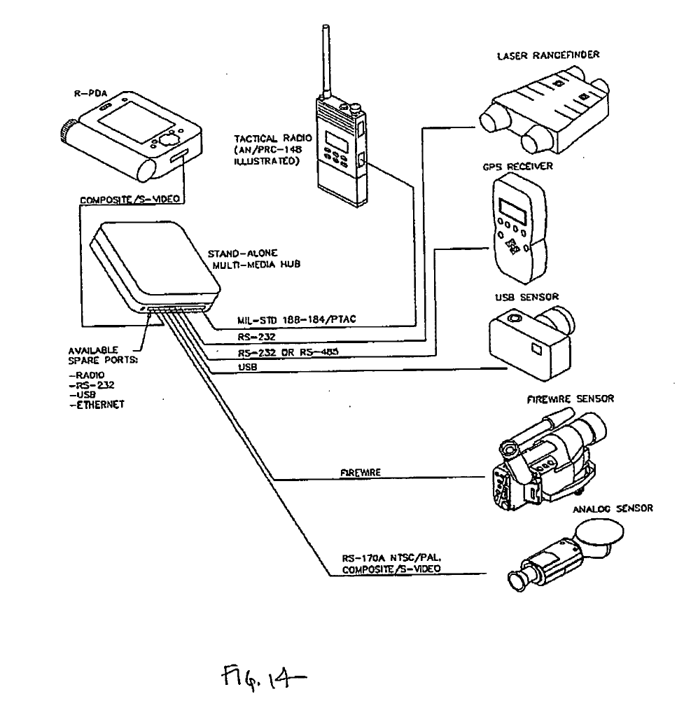

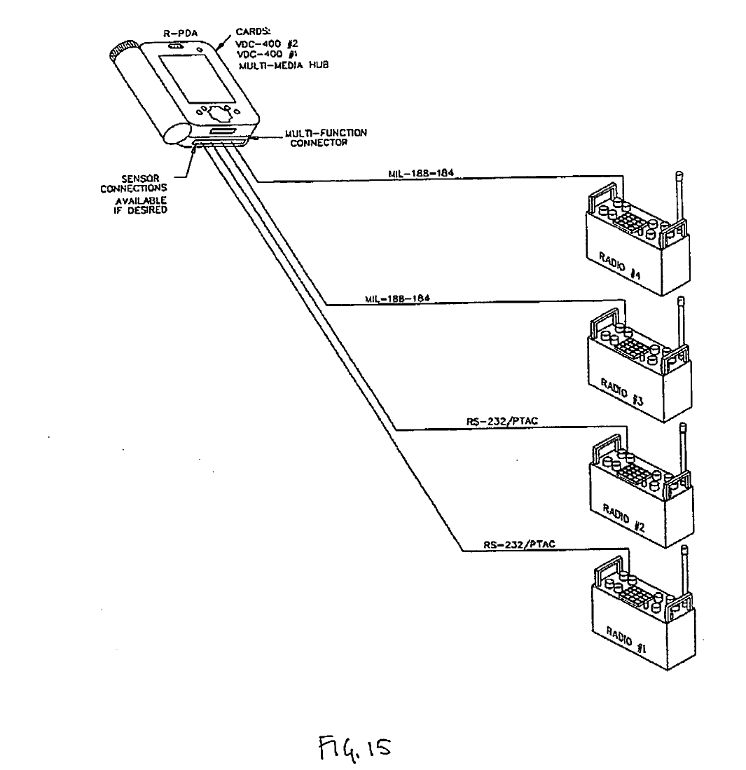

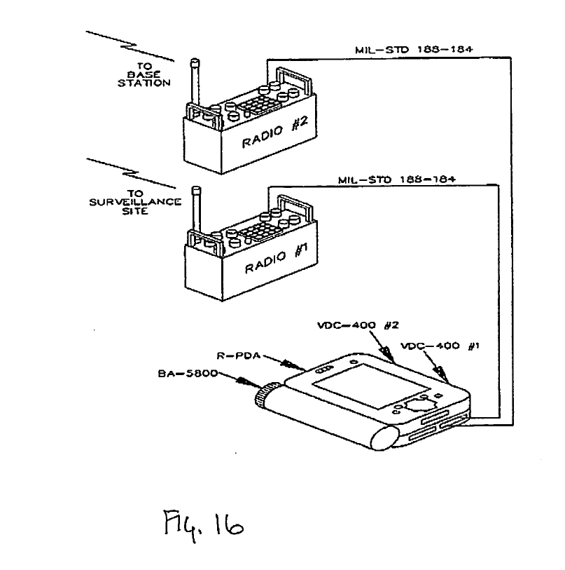

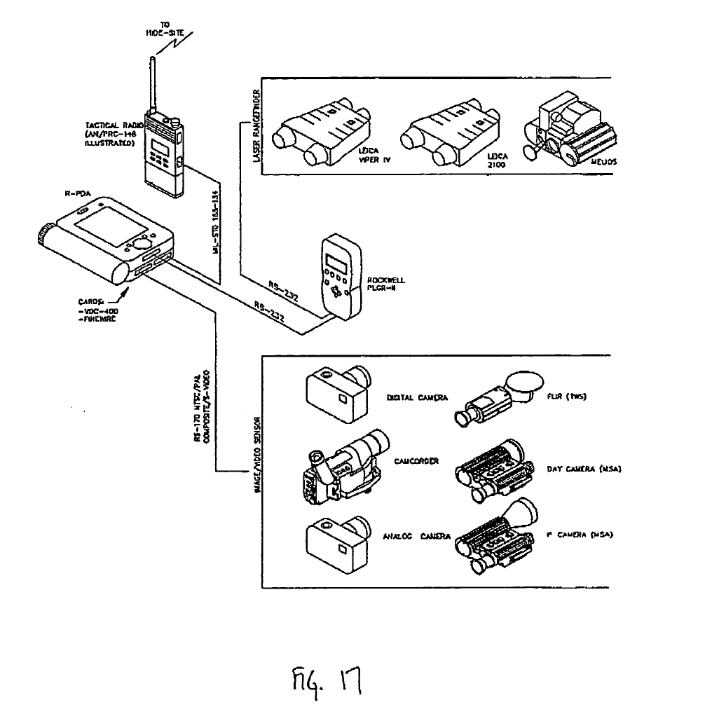

2.1.1.1 Hide Site, or Surveillance Site with No Video Sensors (FIG. 1)

A Hide Site (or Surveillance Site where no image or video collection is required) is equipped in the following manner:
a) PCMCIA Slot 1—VDC-400 Card for Radio #1
b) PCMCIA Slot 2—VDC-400 Card for Radio #2
c) RS-232/USB Port—Spare

Please note that the RS-170A Video Input port that will be provided will operate to either NTSC or PAL standards, and will provide an electrical interface for either Composite (lower quality) or S-Video (higher quality.) It can be utilized to capture either monochrome video or color video.

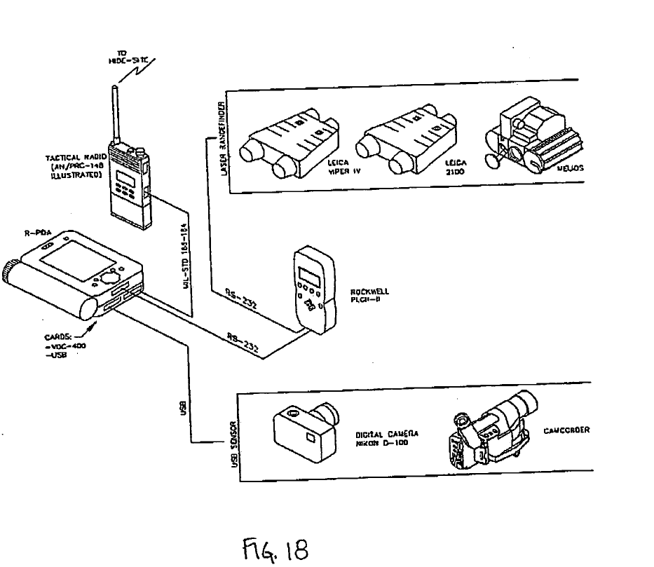

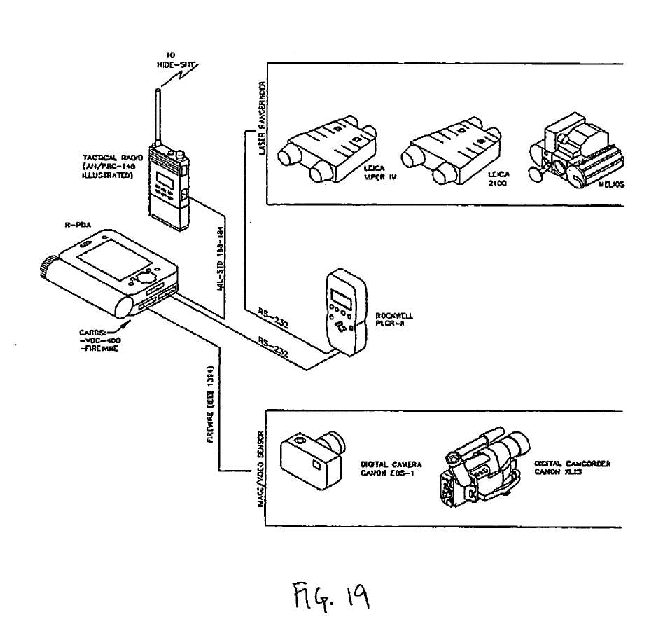

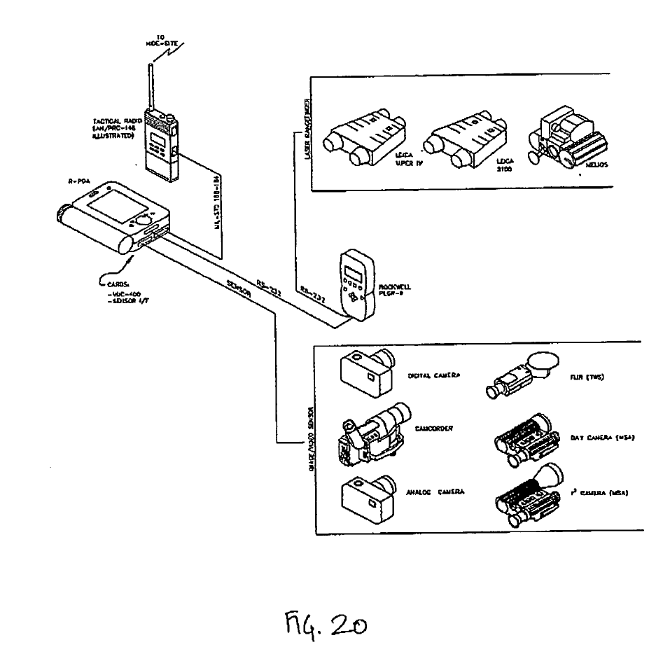

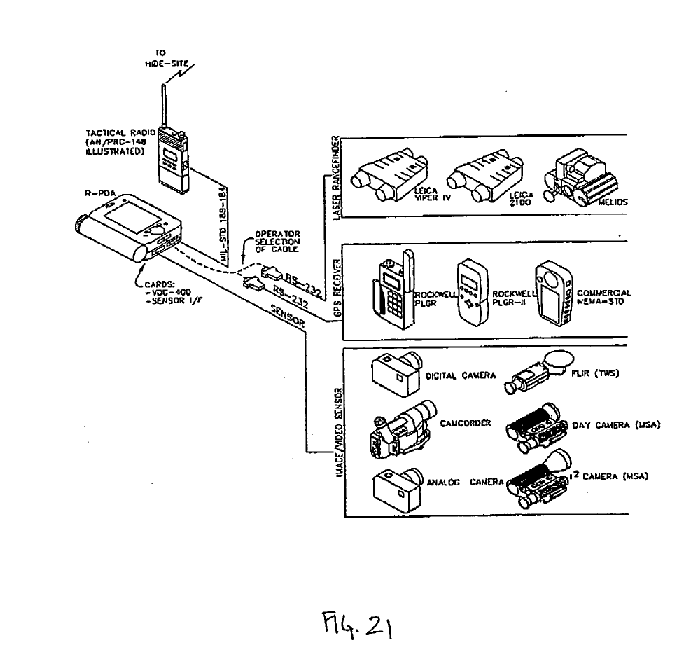

2.1.1.2 Surveillance Site with Analog Video Sensors (FIG. 2)

A Surveillance Site with analog image or video sensors is equipped in the following manner:
a. PCMCIA Slot 1—VDC-400 Card for Radio
b. PCMCIA Slot 2—RS-170A Video Capture Card
c. RS-232/USB Port—GPS and/or Laser Rangefinder

2.1.1.3 Surveillance Site with USB Video Sensors (FIG. 3)

A Surveillance Site with USB image or video sensors is equipped in the following manner:
a. PCMCIA Slot 1—VDC-400 Card for Radio
b. PCMCIA Slot 2—USB Card (Master Mode)
c. RS-232/USB Port GPS and/or Laser Rangefinder

Note that although the R-PDA has an USB port as part of its basic configuration, the vendor has specified that that USB port is a SLAVE port. It is provided to accomplish program loading and synchronization with a host computer, such as a laptop. Image/Video Sensors equipped with USB interfaces, such as Digital Cameras, Camcorders, and Streaming Cameras, require a host that has the USB Master capability.

Because the R-PDA is only equipped with a USB Slave, when operating with USB Image/Video devices, a PCMCIA. USB controller is installed in one of the card slots.

Many current generation image and video capture devices are now using this standard. USB Devices to be tested include:
A Digital Camera (Nikon D-100)
Analog and Digital Camcorders (Sony Family)

2.1.1.4 Surveillance Site with FIREWIRE (IEEE 1394) Sensors (FIG. 4)

A Surveillance Site with Firewire (IEEE 1394) image or video sensors is equipped in the following manner:
a. PCMCIA Slot 1—VDC-400 Card for Radio
b. PCMCIA Slot 2—Firewire (IEEE 1394) Card
c. RS-232/USB Port—GPS and/or Laser Rangefinder

Many current generation image and video capture devices are now utilizing this popular standard, and its popularity is increasing. Firewire Devices to be tested include:
A Digital Camera (Canon EOS-1)
A Digital Camcorder (Canon XLS Is)

2.1.2 GPS and Laser Rangefinder Interconnection

The R-PDA Platform has one RS-232 port. That port must support both GPS and Laser Rangefinder (LRF). There are three technical approaches to this:

2.1.2.1 Use of PLGR-II GPS Daisy Chain Capability (FIG. 5)

The Rockwell PLGR-II has been designed with two independent RS-232 ports that allow the connection to a host (the R-PDA) and a Laser Rangefinder simultaneously. The Laser Rangefinder data can be imported to the GPS, then exported to the host on one RS-232 channel. Use of a PLGR-II and a compatible Laser Rangefinder is the ideal configuration for DRSTA.

2.1.2.2 Manual Connection of GPS and LRF (FIG. 6)

If a deployment is to include a PLGR (or a commercial GPS such as the Garmin “eTrex Legend” that is being used on some military training and real-world operations) as opposed to a PLGR-II, or if it is with a PLGR-II but the Laser Rangefinder is not compatible with the PLGR-II import/export technique, ten another method must be utilized.

The obvious method is to manually plug and unplug the cable. Either one or two cables would be required, depending on the connectors on the GPS and Laser Rangefinder.

2.1.2.3 Switching Cable for GPS or LRF (FIG. 7)

If it is not desirable to plug and unplug cables in the manner described in 2.1.2.2., a “Y” cable approach with a switching technique can be implemented. This can either be manual, or automated with intelligence in the cable “Y” junction.

2.1.3 Hide Site Configurations (FIG. 8)

The Hide Site may be configured with an R-PDA such as is described in 2.1.1.1. This would eliminate the capability of accepting data from most video sensors at the hide site location.

If additional capability is needed at the Hide Site, or if a large screen is required for ease of use, a rugged laptop computer may be utilized. With the laptop computer additional ports are available, and PCMCIA cards may be field-swapped to allow increased functionality.

2.1.4 Base Station Configuration (FIG. 9)

The specified base station is tie LVRS Base Station.

The LVRS Base Station Computer is equipped with two PCMCIA Cards for communications. This allows one channel to be utilized for LVRS communications using the PTAC protocol and one channel to be utilized for DRSTA communications utilizing the MIL-STD-188-184 protocol.

Enhancements to the Base Station Software may be desired or required. The Government has specified that these modifications will not be part of the DRSTA program.

### TECHNICAL APPROACH—ALTERNATE PROPOSAL

There are three fundamentally different technical approaches that can be taken to meet the general DRSTA requirements:

1.1 Card Configuration Approach

The requirements for DRSTA dictate supporting a multitude of varying interfaces for sensors and radios. Currently no PDA device can support all of the wide variety of needed interfaces, nor will one ever be a COTS item. The Card Configuration approach utilizes COTS PCMCIA cards to configure a COTS PDA for Hide Site and Surveillance Site functions. The Surveillance Site further has to be configured based on the Video Sensor interface that is required.

The advantage of the Card Configuration approach is that the system can be implemented with available industry cards without hardware development (other than cable and connector packaging) and can be integrated with software development.

The disadvantages of the Card Configuration approach are several:
Dissimilar Sensors, such as Analog Video and Firewire, cannot be supported simultaneously during a deployment.
A multiplicity of configurations is required to accommodate the inventory of dissimilar sensors.
Hide Site and Surveillance Site Configurations for sensors are not the same and can't be interchanged during a mission.
The difficulty of changing from one sensor interface to another is problematic (it is not a field operation).

1.2 Multi-Media Hub (MMH) Approach

The MULTI-MEDIA HUB is an intelligent circuit that supports all of the host, radio and sensor interfaces that are not normally found in PDA (and laptop) devices. The circuit also has specialized video and audio processing on board to do high-speed compression.

The advantages of the MMH approach are several:
The MMH provides ALL of the required interfaces on-board simultaneously so all devices are supported in the field.
No swapping or re-configuration is required to support different devices.
The MMH approach allows one configuration for both the Surveillance Site and Hide Site.
Additional Radios can be connected allowing multiple net access.
The MMH has specialized communications, audio and video processing that provide additional performance over other approaches.

The disadvantage of this approach is that the MMH is still currently under development and requires additional hardware and software development effort to complete.

1.3 Bluetooth Approach

Bluetooth is available on COTS PDA and Laptop devices. For the near-term, Bluetooth adapters can be built for radio and sensor devices to allow them to talk to PDA's and Laptops. Ultimately Bluetooth can be integrated directly into the devices, and in fact, will likely be in the next generation of commercial devices such as digital cameras and camcorders.

Bluetooth is attractive because of one simple reason—no unwieldy and failure prone cables would be required.

The disadvantages of Bluetooth are:
Bluetooth is not yet approved for Military use.
There are multiple Security Issues.
Bluetooth may be Jammed.
OCONUS spectrum regulations do not yet universally allow Bluetooth operation. (They likely will.)
Hardware development is required to produce several ‘flavors’ of Bluetooth adapters to provide fully for operation of all sensors and radios with Bluetooth.

Based on the above analysis and clarifications provided by the Government, we have decided to submit a base proposal that implements the Card Configuration approach and an alternate proposal that implements the Multi-Media Hub approach. The Multi-Media HUB approach is described in detail in the following paragraphs.

2. In-Depth Technical Discussion

2.1 Multi-Media Hub (MMH) Approach

A circuit card has been developed that can allow a plurality of multimedia sources to be interfaced to a host system. The MULTI-MEDIA HUB card is an intelligent circuit that supports all of the host, radio and sensor interfaces that are not normally found in PDA (and laptop) devices. The circuit also has specialized video and audio processing on-board to do high-speed compression.

The advantages of the MMH approach are several:
The MMH provides ALL of the required interfaces on-board simultaneously so all devices are supported in the field.
No swapping or re-configuration is required to support different devices.
Additional Radios can be connected allowing multiple net access.
The MMH approach allows one configuration for both the Surveillance Site and Hide Site.

The MMH has specialized communications, audio and video processing that provide additional performance over other approaches.

2.1.1 MMH Technology

The MMH is a multi-media signal router. Signals of one format may be received on one port, then communicated out another port. The ports may be of identical or differing electrical interface, and the protocols used may be the same or different. In some instances data conversion of data coming in on one port is performed in the MMH before being passed out another port. An example of this is the conversion of uncompressed streaming video on a Firewire port to a stream of compressed video going out of a USB port. Another example is bringing radio data in on a Radio port using one protocol, then sending it out on the USB port using another protocol.

In the DRSTA application, the MMH would talk to the host computer via a USB port. The current design of the MMH circuit supports an RS-232 interface. This system can be modified for the DRSTA program such that it can communicate to the R-PDA utilizing the R-PDA using its USB (Slave) connection, or communicate to a Laptop Computer for expanded Hide Site or Base-Station operations utilizing USB (Master) or Ethernet 10/100 Base-T connection.

2.1.1.1 MMH Printed Wiring Board (FIG. 10)

The first-generation card is 4.9 inches by 2.9 inches. This card is designed such that it is small enough to fit inside of the R-PDA deep housing.

The design of the second-generation card will provide a full complement of simultaneous interfaces as follows:

Host:
USB (Master or Slave)
Ethernet 10/100 BaseT

Sensors:
Comms #1—RS-232, MIL-STD-188-184 (For Radio)
Cons #2—RS-232, MIL-STD-188-184 (For Radio)
Comms #3—RS-232 with PTT for Radio (For Radio or Sensor)
Comms #4—RS-232 or RS-485 with PTT (For Radio or Sensor, including SLP)
USB #1 Master (For Sensor or Peripheral)*NEW
USB #2 Master (For Sensor or Peripheral)*NEW
Firewire—IEEE 1394 (For Sensor or Peripheral)*NEW
Ethernet 10/100 Base-T
Analog Video Input, RS-170A, NTSC or PAT Standard, Composite or S-Video
Stereo Audio Input*NEW
Analog Video Output, RS-170A, NTSC or PAL Standard, Composite or S-Video
Stereo Audio Output*NEW

Other interfaces could also be supported by this architecture upon request.

2.1.1.2 Block Diagram Discussion

USB Host Communications

The primary connection to the host R-PDA or Laptop computer is through the USS port. The MMH looks like a Master when talking to a PDA. It looks like a Slave when talking to a Laptop Computer.

On-Board Four-Port USB Hub

The MMH contains a Four-Port USS Hub. This provides for:
One Port for the Host Computer
One Port for the Internal MMH electronics
Two Ports for External Sensors or Other Devices

USB Interface

An on-board USB Controller Chip allows the AH processor to communicate to the Host Computer, Sensors and Other Devices through the USB hub. The Controller Chip is programmed to act either as a Master or a Slave depending on the system requirement.

Controller Processor

An on-board Processor with RAM and Flash-Ram acts as the MMH controller. Its software is downloadable from the Host Computer to provide for initial loading and changing of firmware.

COMMS I and COMMS 2—VDC Controllers

Two Viasat VDC-400 cards provide for two Radio Interfaces. These support the MIL-STD-188-184 Protocol.

COMMS 2 and COMMS 3—EIS Controllers

Two programmable EIS communications circuits provide for additional Radio or Sensor interfaces. The EIS circuits can operate either asynchronous or synchronous modes, and can support TCP-IP Protocol, PTAC Protocol, and others as needed by the sensors such as SLP. The EIS controllers contain additional circuitry, such as phase-lock-loop data recovery circuits and PTT contact closure that are needed for Radio control.

Firewire Controller

A Firewire controller allows the MMH to talk to Firewire devices utilizing the IEEE 1394 standard.

Ethernet Controller and PHY

The Ethernet Controller and PRY provide an industry standard 10/100 Base-T network interface. This may be utilized to interface to the Host Computer, such as a Laptop, to a TOC Network, or to special sensor systems that are equipped with 10/100 Base-T interfaces. Use of the Ethernet Controller is beyond the scope of this contract and it will not be supported.

Video/Audio CODEC

A parallel processing chip in conjunction with a RAM chip does real-time full-motion video and audio compression and de-compression. It also provides for the Frame Grabber function to capture still images from video streams.

Audio and Video Decoder

Incoming Audio and Video is processes and converted from analog to digital by this chip. The digital stream is sent to the CODEC for compression. The Video Decoder processes both NTSC and PAL format signals, and will accept either composite or S-Video signals.

Audio and Video Encoder

Baseband digital video and audio streams are converted to analog by the Audio and Video Encoders. The Video Encoder produces either NTSC or PAL format signals, and simultaneously generates composite and S-Video signals. Note that the Encoder and Decoder must both be set for either NTSC or PAL. They are dependent.

Bluetooth Radio

An on-board Bluetooth Radio is provided for sending and receiving audion and full-motion video and signals. This is beyond the scope of the DRSTA application and will not be utilized.

Note that audio and full-motion video functionality are beyond the scope of the DRSTA project and will not be utilized. The CODEC, Video Decoder and Video Encoder will be utilized for capturing still frame images from analog video however.

2.1.2 MMH Applied to DRSTA

The MMH technology and card can be applied to DRSTA in two formats:
Embedded in the R-PDA, and
Stand-Alone for attachment to basic R-PDA's or Laptops.

2.2.2.1 R-PDA with Embedded MMH

The following figure illustrates the MMH card embedded in the R-PDA housing. All of the channels are brought out on a large Multi-Function Connector. The R-PDA may be utilized with Connector Adapters that carry a variety of connectors as are needed, or Break-Out Cables may be provided to interconnect to standard devices.

The MMH is powered by the same Power Input as the R-PDA. If the R-PDA is operating on a BA-5800 battery, the MMH is powered by the same battery. Power Management is utilized such that the power drain to the system is minimized when the ports are inactive.

2.2.2.1 R-PDA with Embedded MMH (FIG. 11)

The following figure illustrates the MMH card embedded in the R-PDA housing. All of the channels are brought out on a large Multi-Function Connector. The R-PDA may be utilized with Connector Adapters that carry a variety of connectors as are needed, or Break-Out Cables may be provided to interconnect to standard devices.

The MMH is powered b y the same Power Input as the R-PDA. If the R-PDA is operating on a BA-5800 battery, the MMH is powered by the same battery. Power Management is utilized such that the power drain to the system is minimized when the parts are inactive.

2.2.2.2 Stand-Alone MMH (FIG. 12)

The MMH packaged in the Stand-Alone Configuration is shown in the figure below. The packaging meets the same general environmental specifications as the R-PDA. The package footprint is identical to the R-PDA so they have the appearance of being of the same ‘family’. The same multi-function UO connector is utilized on both the R-PDA embedded configuration and the Stand-Alone Configuration, thus allowing use of the same cables.

2.1.3 DRSTA Configurations Based on the MMH

The configuration management for DRSTA is greatly simplified with the MMH. The Government can choose to embed the MMH in the R-PDA, or can choose to implement the entire system with the Stand-Alone MMH with absolutely no modifications to the R-PDA.

2.1.3.1 Surveillance Site with R-PDA with Embedded MMH (FIG. 13)

The most compact and versatile implementation for the Surveillance Site is illustrated in the following figure. This shows the MMH card embedded in the R-PDA.

Surveillance Site With R-PDA and Stand-Alone MMH (FIG. 14)

The Surveillance Site can also be implemented with a basic R-PDA and the Stand-Alone MMH. This is illustrated below.

2.1.3.3 Hide Site with R-PDA with Embedded MMH (FIG. 15)

The same configuration that is utilized for the Surveillance Site can also be utilized for the Hide Site. This is illustrated below. A Hide Site can also be implemented with a Stand-Alone MMH operated in conjunction with a basic R-PDA (not illustrated) in the same manner as 2.1.3.2 above. Note that more radios can be simultaneously supported with the MMH technology than can be supported by a basic R-PDA using PCMCIA adapters.

Hide Site or Base Station with Stand-Alone MMH.

A stand-alone MMH can be connected to a Rugged Commercial or a Hardened Military Laptop Computer. This provides the communications channels to a basic computer, and provides larger numbers of channels for access to more nets.

Background

PhotoTelesis Corporation is pleased to provide this information in response to the Government's Solicitation Number D07-03-R-J016 that was issued on Dec. 18, 2002 seeking proposals for software development for use on the DRSTA Program Surveillance and Hide Site Computers.

PhotoTelesis has installed more than 1000 systems with the Department of Defense, Federal law enforcement, and intelligence groups. A unique blend of Independent Research and Development, combined with commercial-off-the-shelf technology, has allowed PhotoTelesis to offer products with innovative designs and superior performance, at competitive prices. The modular construction of our products allows easy technology insertion of hardware and software enhancements to lower life cycle costs.

PhotoTelesis Corporation developed a user-friendly software application called Imaging and Communications Environment (ICE) that is presently used on hand-held processors, nagged laptop and notebook computers as well as on integrated platforms on various fixed and rotary wing aircraft PhotoTelesis also designed and manufactures the U.S. Army's LVRS Out Station and Base Station equipment referenced in the solicitation.

To ensure optimum performance in the hands of the user, we work closely with them to understand the technical requirements, operational environments, as well as existing or planned interfaces with other items of hardware and software.

1.0 Introduction

PhotoTelesis has more than 15 years of relevant experience in software development and integration directly related to the DRSTA requirements. In fact, PhotoTelesis delivered nearly 500 sets of Out Station and Base Station equipment for fielding during the last 7 years for scout surveillance and reconnaissance missions.

With the exception of the JVMF message specific support, PhotoTelesis has fielded multiple configurations of systems that support all of the requirements put forth in the Solicitation Statement of Work, including report generation, MIL-STD-188-184 support via the ViaSAT VDC-400 data controller, interfacing with the MELIOS and Leica Vector (Viper) Laser Rangefinders, interfacing with the PLGR GPS, image capture and annotation, data reception and transmission, and embedded applications development in the Windows CE environment.

2.0 Technical Approach

PhotoTelesis has recent experience in all DRSTA functionality requirements:

Windows CE-based S/W Application

The Windows CE software development experience gained on the Army LVRS MMR, Navy FTI-II program PRISM-IDM program and other embedded projects is quite similar to that required for the DRSTA Surveillance and Hide site computers.

Communications Interface with Standard Army Tactical Radios

PhotoTelesis currently interfaces with many standard military tactical radios including all or those identified in the DRSTA solicitation. This includes both hand-held, ground mobile, surface fixed, and airborne systems.

Two Independent Communications Channels

The Military MicroRIT (MMR) that PhotoTelesis currently delivers to the Army, provides a dual channel communications capability with one channel dedicated to MIL-STD-188-184 (via VDC-400) and the other channel used for secure synchronous/asynchronous communications. The Base Station notebook computer with the ICE application software is also capable of dual communications and specifically two simultaneous MIL-STD-188-184 sessions. A key software development task of the DRSTA project will be to include this capability on the R-PDAs.

Data Interface with PLGR and PLGR II GPS Receivers

PhotoTelesis implemented the protocol for interface with the Rockwell PLGR on the MMRs now being deployed within the U.S. Army. An early task under the DRSTA contract will be to verify that the PLGR II interface is compatible. If necessary, software modifications will be made to ensure support for both devices.

Data Interface with Digital MELIOS and VIPER (Leica Vector) Laser Range Finders

PhotoTelesis implemented the Sensor Link Protocol (SLP) interface for communicating between the MMR and the Digital MELIOS. This interface operates under Windows CE and therefore porting to the DRSTA R-PDA is considered to be a low risk task. PhotoTelesis also has interfaced the Leica laser rangefinder in the MARS program, however this was not in the Windows CE environment. An early task under this project will also ensure compatibility with the VIPER range finder in the Windows CE environment.

Data Interface with Imaging Sensors

PhotoTelesis has interfaced with a variety of digital cameras and camcorders, as well as other sensors such as FLIP. Based upon the solicitation requirement, the Contractor is already experienced in image collection for RS-170 sensors and digital (USB) devices.

JVMF Message Interface and Processing

PhotoTelesis supports several report formats that can be associated and attached to images. Although additional report formats identified in the DRSTA solicitation must be created for the R-PDA, the effort to do so is considered low risk.

Image and Text Handling Capability

PhotoTelesis is well known for its imaging software application (ICE). This software is NITFS-CLEVEL 3-v.2.1 certified and provides seamless communications over military tactical radios. Specifically, ICE permits user friendly, image collection, manipulation, enhancement, and annotation. This includes cropping, annotation with text, and graphics such as triangle for target identification, and North-pointing arrow for reference.

3.0 System Requirements

The LVRS equipment presently being fielded to U.S. Array Special Forces organizations consists of a man-portable Out Station and a transportable Base Station. Key Out Station components include the hand-held MMR with keyboard, day and night sensors, and video and communications cables. The Base Station includes a notebook computer, ink jet printer, power inverters for operation from both 12 volt and 24 volt sources, and associated cables. The present equipment provides the ability to capture, transmit, and receive image and textual data between Out Stations and Base Stations. In the DRSTA Program, the R-PDA will be used for both the Scout/Surveillance and Hide Site stations. However, it may be required to configure the R-PDA differently for each location. For example, the Surveillance application may be better served with a single VDC-400 and one video capture card while the Hide Site location R-PDA would be configured with two VDC-400 data controllers. If the GFE R-PDA is field configurable this is easily accomplished.

3.1 System Software Functional Requirements 3.1.1 Communications

PhotoTelesis designs and manufactures a variety of off-the-shelf products for Government organizations. The LVRS is designed to capture and exchange still frame images using a variety of Government fielded radios to enhance reconnaissance capabilities. These radios include SINCGARS, PSC-5 (Spitfire), PRC-117F (Falcon II Multiband), PRC-148 (MBITR), and PRC-150 (Falcon II HF). The LVRS system includes portable computers that are capable of supporting a wide range of computer applications for messaging, mapping and analysis.

PhotoTelesis will develop software to provide support for up to two (2) independent STD-188-184 communications sessions using the ViaSAT VDC-400 data controller. Data exchanged during the communications session will include JPEG image files, ASCII text files, JVMF messages, and ViaSAT chat messages.

3.1.2 Messaging

The Contractor will develop software to provide support for the generation and viewing of the 12 JVMF message types listed in paragraph 3.1.2 of the Solicitation Statement of Work. This includes the creation of the user interface that will enable the operator to prepare, review, and transmit the desired reports.

3.1.3 Image Handling

The Contractor will develop software, based on the existing software incorporated in the MMR, to support image handling. This will include operations for image cropping, re-sizing, image annotation with symbols and text, and associating ASCII text files with a specified image.

3.2 Computer Hardware

The Contractor assumes that the Government will provide all of the items listed in paragraph 3.2 of the solicitation unless directed otherwise by the Government Contracting Officer. The Contractor also assumes that device driver(s) to support external plug-in hardware and the corresponding device driver ICD(s) are provided unless otherwise specified by the Government Contracting Officer.

4.0 Deliverables and Reporting

The deliverables identified in section 4.0 of the solicitation are addressed in paragraphs 4.1.1 through 4.1.7 that follow.

4.1 Task 1—Program Management

4.1.1 Monthly Status Reports

In addition to regular informal contacts with the CACI program manager, a status report will be submitted to provide status of project accomplishments. This report will be sent via e-mail NLT the 10^{th} of the month for the previous month's effort. This will enable CACI to respond to the Government by the 15^{th} of the month as required.

4.1.2 Software Requirements Specification

PhotoTelesis will prepare and submit a Software Requirements Specification (SRS) to clearly identify the requirements that must be met during the 12 month period of performance of the contract. The SRS will be submitted for review and approval NLT 60 days after contract award. The Contractor will address reviewer comments within 5 working days after receipt

4.13 Requirements Management Plan

The Contractor has an established, ISO process for project development and also uses software tools such as “Source Salt” to track and manage software Releases and Versions. The process begins with an analysis of the contract requirements to ensure that project activities result in accomplishment of desired Customer objectives. These requirements, when clearly understood by all members of the Customer/Contractor project team, become the documented and Customer approved baseline for the software development, integration, and test activities that follow.

At this point, we begin an iterative process or developing, evaluating, and reviewing the code by the software engineering team. This ensures that the software being developed satisfies Contract requirements, is documented, and can be tested and verified throughout the project leading up to the final design verification prior to loading onto the R-PDAs for final acceptance testing and delivery to the Customer. Progress attained during this development process will be reported to the Customer in each monthly status report.

4.1.4 Software Project Plan

The Contractor management objectives for the DRSTA project are to plan and execute a Best Value program in accordance with the Customer's technical requirements, and complete the contract activities within 12 months after contract award. A time-phased Software Project Plan will be prepared defining the development, integration, and testing activities that will be accomplished to ensure that the project is completed on schedule. This project plan is approved by the Customer, and the Contractor will report progress to the plan each month.

The software development engineering personnel who will be assigned to this project are already on our staff This includes individuals with experience writing kernel mode software, device driver, and applications software using Windows CE. These individuals also have the necessary DoD Secret security clearance as required by contract.

4.1.5 Software Test Plan

The PhotoTelesis software process consists of four stages: requirements, design, implementation, and evaluation. These stages are the basic building blocks of our software engineering process. The following actions take place in each stage:
Requirements stage—The project team analyzes the system-level requirements of the Customer's Contract Statement of Work and produces requirements specific to software that support design and testing.
Design stage—The team creates a software design that meets the software requirements. Various designs are studied during this stage and the best design is selected. The design stage is complete when the project team knows how to build the software and how to test that it conforms to the design.
Implementation stage—The team develops the software product.
Evaluation stage—The team confirms that the completed software product meets the requirements.

Progress during each stage is tracked and reported to the Customer in the monthly reports. PhotoTelesis will develop and test all software on standard PCs, on PDA simulators, and on the GEE provided R-PDAs. This process identifies problems as the project proceeds and enables the software engineering team to resolve those problems quickly, ensuring that the final released soft ware that will be delivered on the R-PDAs meets Customer requirements.

4.1.6 Configuration Management Plan

The Contractor software configuration management system provides simple but rigorous control of the DRSTA software configuration. A person will be assigned to manage this system and safeguard the associated computer libraries. The process already in place provides the management framework to control and status all modifications to existing code or for new development during the contract. The DRSTA Software Requirements Specification (SRS) will establish the software product baseline upon Customer approval. All proposed changes to this baseline must be submitted to the Customer for approval after which an updated SRS will be generated.

4.1.7 Final Report

PhotoTelesis will prepare and submit a final Technical Progress Report within 10 days of project completion to enable CACI sufficient time to submit their final report to the Government NLT 15 days after the end of the period of performance for the contract. This report will provide a review of the entire program with emphasis on cost, schedule, and technical performance aspects.

4.2 Task 2—Hardware and Software 4.2.1 Hardware Acquisition

The Contractor understands that the thirty-two (32) VIASAT VDC-400 PCMCIA Data Controllers and sixteen (16) R-PDAs will be delivered to us as GFE. The Contractor will load the DRSTA software code onto the 16 PDAs, will verify through an acceptance test that each unit complies with contract requirements, and will deliver the systems to the Customer at the conclusion of the project.

4.2.2 Software Development

The Contractor will provide for the development of a Windows CE application and associated device drivers, as required, that provides for the following minimum features:
Bi-Directional Data Flow Between the Surveillance/Hide/Base Site.

The Contractor will provide for two-way communications between the Hide Site and Surveillance Site and between the Hide Site and Base Station. The data exchanged between sites will include JPEG image files, JVMF messages and ASCII text messages. Each site will support up to two (2) independent MIL-STD-188-184 channels utilizing ViaSAT VDC-400 data controller(s).
Generation and Display of JVMF Messages.

The Contractor will provide the user of the DRSTA Hide Site computer the ability to generate JVMF messages as specified in paragraph 3.1.2 of the Solicitation Statement of Work. The Contractor will also provide for the viewing of JVMF messages generated on or received by the Hide Site computer.
Display and Annotation of JPEG Images.

The Contractor will provide the user of the DRSTA Hide Site computer with the ability to view, annotate, resize, and save JPEG images. The annotation will include both text and graphic symbology. In addition, ASCII text files may be generated and associated with a selected image.
Interface with External Imaging Sensors.

The contractor will provide a method for interfacing with external imaging sensors in order to retrieve imaging data for later annotation and or transmission to the Elide Site or Base Station.

4.2.3 System Integration and Test

The Contractor will support integration of the Surveillance/Hide Site R-PDAs with the DRSTA Base Station. The solicitation indicates that the Base Station to be used will be a “modified LVRS base station”. PhotoTelesis is the Prime Contractor for the LVRS Program and has extensive experience with the design, development, and evolution of this base station equipment since the program's award in September 1995. The base station computer uses the PhotoTelesis Imaging software application (ICE) that provides demonstrated, user-friendly communications with each of the radios identified in this solicitation. Therefore developmental and operational testing of the DRSTA equipment will be conducted with the LVRS Base Station Computer throughout the contract period of performance to ensure end-to-end compatibility from the Surveillance Computer, to the Hide Site computer, to the Base Station Computer.

4.2.4 Software Testing

The Software Test Plan described in paragraph 4.1.5 above provides the foundation for our software development and test program. The Contractor will prepare the Software Test Description requested by the solicitation. We call this document the Design Verification Test (DVT) Plan that is prepared based on the Customer's requirements and our internal software design and test plans. The DVT must be successfully accomplished before the software can be released. Then the software is loaded on the GFE R-PDAs for final acceptance testing by Contractor Quality Assurance personnel prior to delivery to the Customer.

4.3—Task 3—Engineering Support 4.3.1 Technical Manual

PhotoTelesis will provide support to CACI for preparation of the Technical Manual. This will include generation of test to describe the functional interface between our software and the GFE R-PDAs as well as illustrations necessary to clarify the operation of the system that is running our software. Overall publication of the manual and support for Customer required reviews or verifications are not being quoted by PhotoTelesis at this time.

4.3.2. System Training

PhotoTelesis will be available to support training of Army personnel either at our San Antonio, Tex. facilities or at some field location. However, no costs are included in the proposal at this time. It is further assumed that CACI will be responsible for generation of the lesson plans and related activity requested by the Government

4.3.3 Field Demonstrations

The Contractor will provide on-site support for three (3) Field Demonstrations with end users at Continental United States Army locations. Each demonstration shall be up to 3 days duration. The Contractor will provide engineers and technical support personnel to ensure a successful demonstration.

5.0 Travel and Other Direct Costs

The PhotoTelesis travel estimate assumes three (3) trips of today duration for three (3) people from San Antonio, Tex. to an unspecified Army installation in the continental United States. This travel is for support of the three (3) Field Demonstrations and includes software engineering/management personnel and a field support technician.

6.0 Period of Performance

The Contractor understands that the period of performance for this activity is for 1 year after receipt of contract. Our planned activity will be completed in that time frame and will result in delivery of tested hardware and software by the end of the 12^{th} month.

7.0 Place of Performance

The software development effort will be primarily performed at PhotoTelesis facilities in San Antonio, Tex. Travel to Government sites for three (3) Field Demonstrations is planned. No other travel is proposed at this time.

8.0 Security

PhotoTelesis already has available, for on-site support, several personnel with a Secret security clearance. All clearance data will be delivered to the appropriate Government Installation(s) prior to travel.

9.0 Basis for Price

A Time and Materials type contract is proposed with monthly Progress Payments based on activity completed the previous month.

10.0 Invoicing and Payment

The Contractor will invoice monthly for actual hours expended in accordance with the labor rates approved for the contract. Travel and other direct costs will be invoiced based upon actual costs.

11.0 Assumptions 11.1 GFE and GFI

It is assumed that the ruggedized PDAs, and associated cables, batteries, and battery chargers will be provided as GFE to the Contractor. It is assumed that no modifications will be required to the hardware for this project. It is assumed that the R-PDA's will be delivered with all the necessary manuals, cables, software media, battery boxes, batteries, and accessories needed for operation.

It is assumed that the Army GPS, Laser Ranging equipment, and Tactical Radios that will be provided as GFE, will be complete with all necessary manuals cables, batteries, key loaders, keying material and accessories needed for operation

It is assumed that any sensors, i.e., cameras, camcorders, FLIRs, or other devices to be tested or evaluated by the Contractor, will be provided as GFE.

It is assumed that the GFE will be provided within two weeks of Contractor request. No project delays due to late shipment of GFE or for failed GEE has been built into our cost estimates.

It is assumed that the Interface Control Document (ICD) for each identified item of GFE will be provided within two weeks of Contractor request.

11.2 Open Market Items

N/A

11.3 Technical Assumptions

The Contractor acknowledges the following assumptions stated in the solicitation:
GFI wall be provided within two weeks of contractor request
Government Subject Matter Experts will be available on projected schedule travel dates.
System development, integration, and implementation are contingent on the availability of GFE.

1. Technical Approach Overview

The DRSTA program technical tasking is primarily software development and hardware integration.

The core applications software is a very modest project, generating relatively straightforward user interfaces, templates for messages, and integrating off-the-shelf Via-Sat software that facilitates the specified communications.

A more difficult area of the project is seamless processing of video from sensors with three totally different interfaces while providing a common and straightforward user interface; a task that we have addressed for other programs and for which have ready solutions.

The most difficult part of the DRSTA project is meeting the requirement of supporting a multitude of varying hardware interfaces for sensors and radios within the constraints of the platforms specified, and doing so in a manner that is not unwieldy to the end-user.

1.1 Architectural Tradeoffs

In Summary, the DRSTA architecture calls for:
A Base Station based on the LVRS Base Station platform, which is well defined,
A Hide Site based on either a R-PDA (Rugged PDA) or a Rugged Laptop Computer, and
A Surveillance Station that is based on a R-PDA outfitted with additional interfaces to support a variety of sensors with a variety of electrical and protocol interfaces.
   The R-PDA that has been selected by the Government for this program is the Tacter built by Talla-Tech. The Tacter, although a solid R-PDA design, has a very limited built-in UO Capability that is commonplace for PDA devices. It has:
One RS-232 Serial Port (with limited flow control signals)
A USB port which is Slave only (not capable of talking to standard sensors)
Two PCMCIA Card Slots

The Contractor is, therefore, required to make architectural trade-offs and decisions on the best manner of supporting the required radio and sensor interfaces in the most user Friendly and cost effective manner. Addressing the integration challenge, the Requirements in the Statement of Work specifics that the integration of the VDC-400 communications cards for radio is mandated and the selection and integration of the sensor interface card(s) is a Contractor task.

1.2 Background Technical Study Undertaken

PhotoTelesis Corporation has done a large amount of background study and has invaluable real-world experience in deploying PhotoTelesis designed and manufactured hand-held tactical surveillance systems. In addition, advanced concepts have been studied previously for other programs and were extensively revisited during the DRSTA bidding process. During the analysis of the specific DRSTA Requirements and the specified GFE devices, it was quickly determined that the system-wide number and variety of I/O devices (Radios and Sensors) is the biggest DRSTA systems integration and software challenge. The problem primarily focuses on the Surveillance Site where a wide variety of video sensors, GPS, and Laser Rangefinders can be utilized. The following five general approaches were evaluated, and compelling conclusions were reached:

1.2.1 Approach 1: Wireless with Bluetooth

Approach: The use of wireless is very compelling because cables for sensor and radio connection would be eliminated and no PCMCIA Slots would be utilized leaving them free for VDC-400 cards. It would be implemented with:
The factory Bluetooth Option installed in the R-PDA
Bluetooth Adapters installed on each sensor
Bluetooth Adaptors on each radio

Conclusion: The use of Bluetooth for DRSTA was readily dismissed because:
Hardware engineering of Bluetooth media converters was required.
Bluetooth has not been approved for battlefield/Military use.
Bluetooth has unresolved security/jamming issues.
Bluetooth has unresolved international spectrum management issues.
The Government responded to our question that Bluetooth is not desired at this time.

1.2.2 Approach 2: USE Used for All Sensors

Approach: A USB bus would be used to accommodate all sensor interfaces. This would allow a single PCMCIA interface card in the R-PDA to support all sensor devices, which is attractive. It would be implemented with:
A USB (Master) PCMCIA card in the R-PDA
A multi-port USB hub to accommodate multiple sensors
A USB to RS-232 adapter provided for the GPS
A USB to RS-232 adapter provided for the Laser Rangefinder (unless PLGR-II is used for the GPS, thus allowing daisy-chain through the PLGR-II).
A USB to RS-170A adapter for Analog Video Cameras
A USB to Firewire Adapter for Firewire Cameras (if needed in the future)
Direct connection of USB equipped Digital Cameras, Camcorders, and Streaming Cameras

Conclusion: The use of USB as the primary bus for sensors for DRSTA was soundly dismissed because:
The use of an external hub device, a variety of media converters and a large number of required interconnect cables is a configuration, although technically appealing, is “total nightmare” for the user.
The use of an external hub device, a variety of media converters and a large number of required interconnect cables would be very unreliable.

1.2.3 Approach 3: A “Multimedia Hub” Internal to the R-PDA

Approach: A circuit card would be developed that integrates all of the above USS hardware into one card packaged internal to the R-PDA, thus eliminating the large number of consumer grade cables and ‘nodules’. That card would provide:
A Serial Port for the GPS
A Serial Port for the Laser Rangefinder
An RS-170A port for the Video Sources
A USB port for the USB equipped Sensors
A Firewire Port for the Firewire equipped Sensors (if needed in the future)

Conclusion: Multimedia Hub Approach was dismissed because:
The envelope of the R-PDA would have to be increased.
The development time was excessive.
The development cost was excessive.

1.2.4 Approach 4: Multiple-PCMCIA Cards Configured as Required

Approach. The Surveillance Site R-PDA would be equipped with the appropriate PCMCIA interface card for the sensor selected for a particular mission. It would be implemented with:
A PCMCIA Frame Grabber Card for RS-170A Analog Video Sensors
A USB Card for USB enabled Sensors
A Firewire Card for Firewire enabled Sensors (if needed in the future)

Conclusion: The use of selected PCMCIA adapter cards is lowest risk, but with disadvantages because:
Cards cannot be swapped in the field to accommodate different sensors. R-PDA's would have to be pre-configured for a particular sensor prior to a mission. This will be a growing problem as more and more sensors move toward USB and Firewire interfaces.
Two Sensors with different interfaces cannot be accommodated in the field at the same lime. A problematic example would be deploying a still camera with USB I/F and a FLIR with a RS-170A output.
There is a shortage of RS-232 channels to operate both a OPS and Laser Rangefinder at the same time unless you are using PLGR-II.

1.2.5 Approach 5: Use of a “Universal” PCMCIA Adapter

Approach: A PCMCIA card that supports ALL DRSTA sensor Requirements would be installed in the R-PDA. It would provide:
A Serial Port for the GPS
A Serial Port for the Laser Rangefinder
A RS-170A port for the Video Sources
A USB port for the USB equipped Sensors
A Firewire Port for the Firewire equipped Sensors (if needed in the future)

Conclusion: The use of a “Universal” adapter is the best technical solution. The disadvantage is that it is an NDI card in development that can be considered higher risk However, the risk is nominal because an NDI card is scheduled to be available within DRSTA program schedules. COTS cards can be utilized during the development cycle and can be used as a backup in case of any delays in the NDI program.

1.3 Technical Similarities: COTS AND NDI Implementation

It is very important to note that the tlvo solutions are the same in that:
The core development specified in Section 4 is exactly the same for both COTS cards and the NDI card,
The per-unit cost of the multiple COTS cards required to do the job vs. the one NDI card is the same,
The additional driver and integration work for the COTS cards and the NDI card is the same,
The development time for the COTS card solution and the NDI card solution is the same, and
The general user interface is the same for the COTS cards and the NDI card.

1.4 Development Comparison of COTS and NDI Implementation

The development project has been analyzed to see the specific areas where the tasks are different for the COTS card and the NDI card. The comparison or tasks follows:

| | |
|---|---|
| S/W Design and Specification | Nearly Identical A or B |
| Card Drivers | Specific to A or B |
| User Interface Construction | Identical for A or B |
| Applications Layer Construction | Identical for A or B |
| JVMF Tasks | Identical for A or B |
| GPS Tasks | Identical for A or B |
| Laser Rangefinder Tasks | Identical for A or B |
| Communications Integration | Identical for A or B |
| System Test Effort | Identical for A or B |
| User Documentation Effort | Similar for A or B |

1.5 Technical Risk Assessment

This Contractor is in a unique position to address the technical development risks because:
We have developed drivers, integrated and deployed the ViaSat VDC-400 PCMCIA card on several platforms for several programs.
We have developed drivers, integrated and deployed COTS PCMCIA interface cards suitable for sensor YO on several platforms and for several programs.
We are currently adapting our video and sensor interface circuits to create a PCMCIA multimedia sensor interface card called the TAC-M TM Card (Tactical Multimedia). The Contractor suggests that the TAC-M is the best value solution for meeting the DRSTA requirements.

1.6 Technical Approach Information

In view of the discussions above concluding that there are two viable approaches, the balance of the Technical Approach section of the proposal will address the following:
Section 2; the system configuration and lower-level driver and integration tasks that integrate currently available COTS interface cards.
Section 3; the system configuration and lower-level driver and integration tasks that integrate the NDI TA C-M interface care
Section 4; the higher-level software tasks that are common to both the COTS cards and the NDI card.

2. COTS Card Integration

The DRSTA implementation is based on the GFE Rugged PDA (R-PDA) that is manufactured by Talla-Tech that is utilized in the Army's CHS-2 program. This R-PDA is based on the Compaq iPAQ 3955 commercial PDA.

The R-PDA supports two internal PCMCIA adapter card slots as well as either a USB (Slave) port or Serial YO port. All interfacing to Radios, GPS, and Sensor Devices must be accomplished within the limitations of this platform.

COTS Card Configuration Approach

The limitations of the platform as set forth above prevent “loading up” of the platform with industry standard interface cards to a degree that would allow support of all modes of operation simultaneously. Because one configuration cannot be made to meet all of the differing requirements, a series of configurations that are mission oriented has been developed.

The Card Configuration approach utilizes insertion of appropriate PCMCIA cards and software into the hosting PDA and Laptop devices to create a mission configuration. Each mission configuration requires a different complement of PCMCIA devices and associated interconnection.

2.1 Standard DRSTA R-PDA and PCMCIA Card Configurations

Four basic R-PDA configurations are envisioned to meet the DRSTA requirements:
1) A Hide Site, or Surveillance Site with no Video Sensors
2) A Surveillance Site with Analog Video Sensors
3) A Surveillance Site with USB Video Sensors
4) A Surveillance Site with Firewire (IEEE 1394) Sensors (if needed)

Each configuration is described in more detail on the following pages.

2.1.1 Hide Site, or Surveillance Site with no Video Sensors (FIG. 16)

A Hide Site (or Surveillance Site where no image or video collection is required) is equipped in the following manner:
a) PCMCIA Slot 1—VDC-400 Card for Radio #1
b) PCMCIA Slot 2—VDC-400 Card for Radio #2
c) RS-2321USB Port—Spare

Please note that the RS-170A Video Input port that will be provided will operate to either NTSC or PAL standards, and will provide an electrical interface for either Composite (lower quality) or S-Video (higher quality.) It can be utilized to capture either monochrome video or color video.

2.1.2 Surveillance Site with Analog Video Sensors (FIG. 17)

A Surveillance Site with analog image or video sensors is equipped in the following manner:
a. PCMCIA Slot 1—VDC-400 Card for Radio
b. PCMCIA Slot 2—RS-170A Video Capture Card
c. RS-2321USB Port—GPS and/or Laser Rangefinder

2.1.3 Surveillance Site with USB Video Sensors (FIG. 18)

A Surveillance Site with USB image or video sensors is equipped in the following manner:
a. PCMCIA Slot 1—VDC-400 Card for Radio
b. PCMCIA Slot 2—USB Card (Master Mode)
c. RS-232/USB Port—GPS and/or Laser Rangefinder

Note that although the R-PDA has a USB port as part of its basic configuration, the vendor has specified that that USB port is a SLAVE port. It is provided to accomplish program loading and synchronization with a host computer, such as a laptop. Image/Video Sensors equipped with USB interfaces, such as Digital Cameras, Camcorders, and Streaming Cameras, require a host that has the USB Master capability.

Because the R-PDA is only equipped with a USB Slave, when operating with USB Image/Video devices, a PCMCIA USB controller is installed h one of the card slots.

Many current generation image and video capture devices are now using this standard Suggested USB Devices to be tested include:
A Digital Camera (Nikon D-100)
Analog and Digital Camcorders (Sony Family)

2.1.4 Surveillance Site with FIREWIRE (IEEE 1394) Sensors (FIG. 19)

A Surveillance Site with Firewire (IEEE 1394) image or video sensors can, for future requirements, be equipped in the following manner:
a. PCMCIA Slot 1—VDC-400 Card for Radio
b. PCMCIA Slot 2—Firewire Card (IEEE 1394) when needed
c. RS-232/USB Port—GPS and/or Laser Rangefinder

Many current generation image and video capture devices are now utilizing his popular standard, and its popularity is increasing. Suggested Firewire devices to be tested include:
A Digital Camera (Canon EOS-I)
A Digital Camcorder (Canon XL1S)

2.2 GPS and Laser Rangefinder Interconnection

The R-PDA Platform has one RS-232 port. That port must support both GPS and Laser Rangefinder (LRF). There are three technical approaches to this:

2.2.1 Use of PLGR-II GPS Daisy Chain Capability (FIG. 20)

The Rockwell PLGR-II has been designed with two independent RS-232 ports that allow the connection to a host (the R-PDA) and a Laser Rangefinder simultaneously. The Laser Rangefinder data can be imported to the GPS, then exported to the host on one RS-232 channel. Use of a PLGR-II and a compatible Laser Rangefinder is the ideal configuration for DRSTA.

2.2.2 Manual Connection of GPS and LRF (FIG. 21)

If a deployment is to include a PLGR (or a commercial GPS such as the Gamin “eTrex Legend” that is being used on some military training and real-world operations) as opposed to a PLGR-II, or if it is with a PLGR-II but the Laser Rangefinder is not compatible with the PLGR-II import export technique, then another method must be utilized.

The obvious method is to manually plug and unplug the cable. Either one or two cables would be required, depending on the connectors on the GPS and Laser Rangefinder.

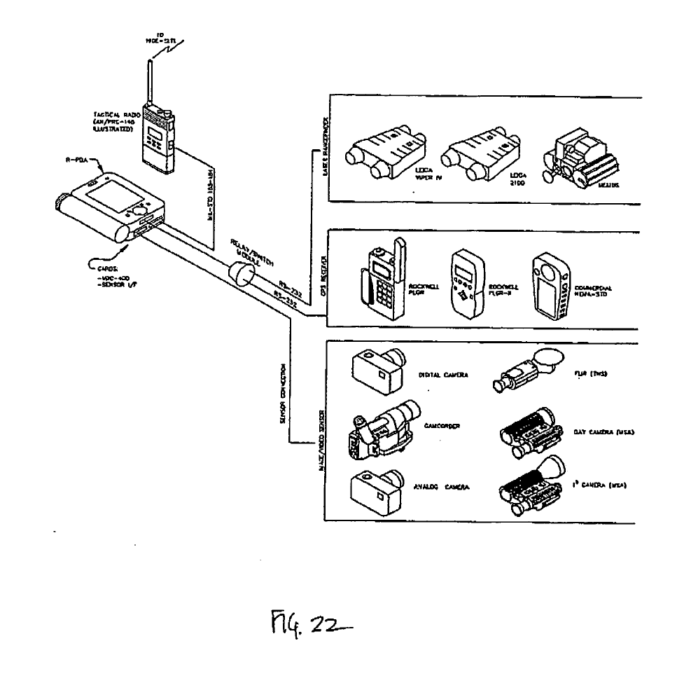

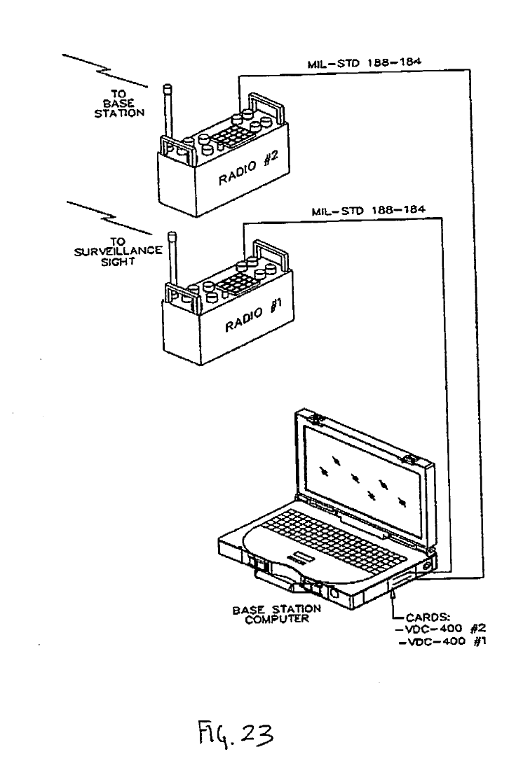

2.2.3 Switching Cable for GPS or LRF (FIG. 22)

If it is not desirable to plug and unplug cables in the manner described in 2.1.2.2., a “Y” cable approach with a switching technique can be implemented. This can either be manual, or automated with intelligence in the cable “Y” junction.

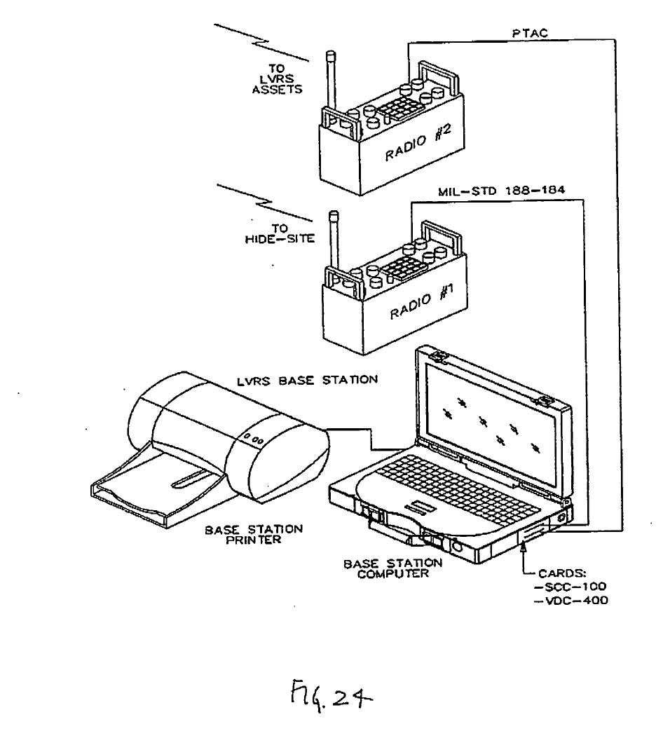

2.3 Hide Site Configurations (FIG. 23)

The Hide Site may be configured with an R-PDA such as is described in 2.1.1.1. This would eliminate the capability of accepting data from most video sensors at the hide site location.

If additional capability is needed at the Hide Site, or if a large screen is required for ease of use, a rugged laptop computer may be utilized. With the laptop computer additional ports are available, and PCMCIA cards may be field-swapped to allow increased functionality.

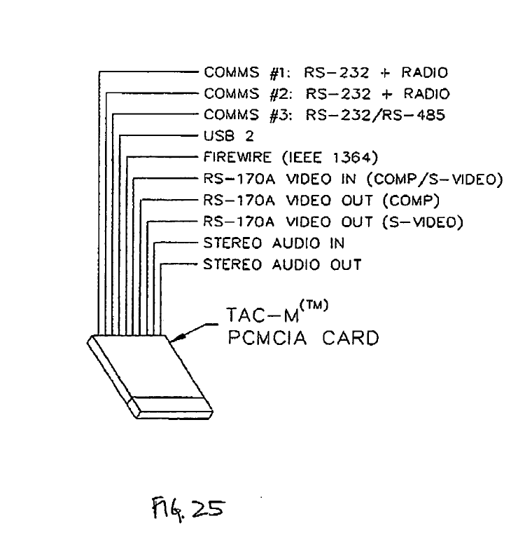

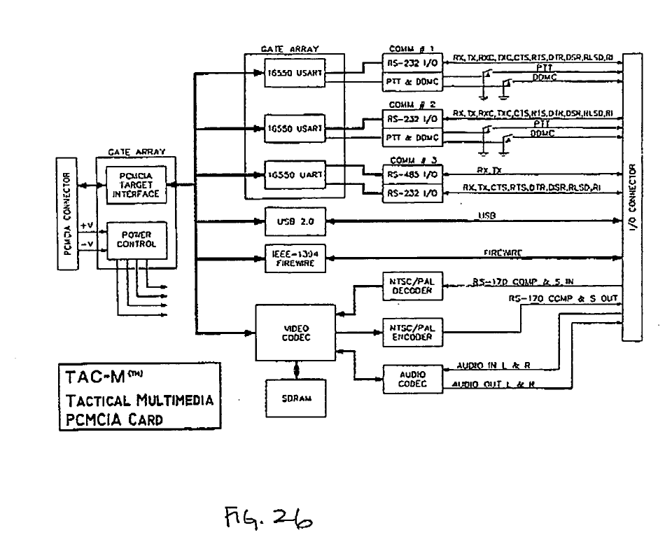

2.4 Base Station Configuration (FIG. 24)

The specified base station is the LVRS Base Station

The LVRS Base Station Computer is equipped with two PCMCIA Cards for communications. This allows one channel to be utilized for LVRS communications using the PTAC protocol, and one channel to be utilized for DRSTA communications utilizing the MIL-STD-188-184 protocol.

Enhancements to the Base Station Software may be desired or required. The Government has specified that these modifications will not be part of the DRSTA program at this time.

3. TAC-M Card Integration (FIG. 25)

As was discussed previously, the limitations of the R-PDA platform used by DRSTA as set forth above prevent “loading up” of the platform with industry standard interface cards to a degree that would allow support of all desired sensors simultaneously. However, a card is under development by PhotoTelesis Corporation that can provide all of the required sensor interfaces simultaneously from one PCMCIA cards

This card, called the “TAC-M” card for Tactical-Multimedia card, is a highly integrated media input device that is based on high-density low-power programmable gate array technology coupled with high-density multimedia video processing chips of the latest generation. Use of the TAC-M card in the DRSTA program provides both the best technical performance and the best value to the Government.

Some of the technology in the TAC-M card has been imported from the design efforts on other programs, including the new miniaturized PRISM FTI-II and PRISM-VTR aviation imaging programs. Technology was also imported from the SCC-100 PCMCIA communications card that is utilized with the PhotoTelesis ICE software. And finally, full motion image IP-Video technology is being imported from the PhotoTelesis designed “e-Watch” full motion streaming products being promoted by Cisco Systems and selected by the Raytheon First Responder program.

The resulting TAC-M architecture provides the missing elements required for utilizing PDA class devices for high performance tactical imaging applications. The extensive multimedia I/O capability of the card is illustrated below:

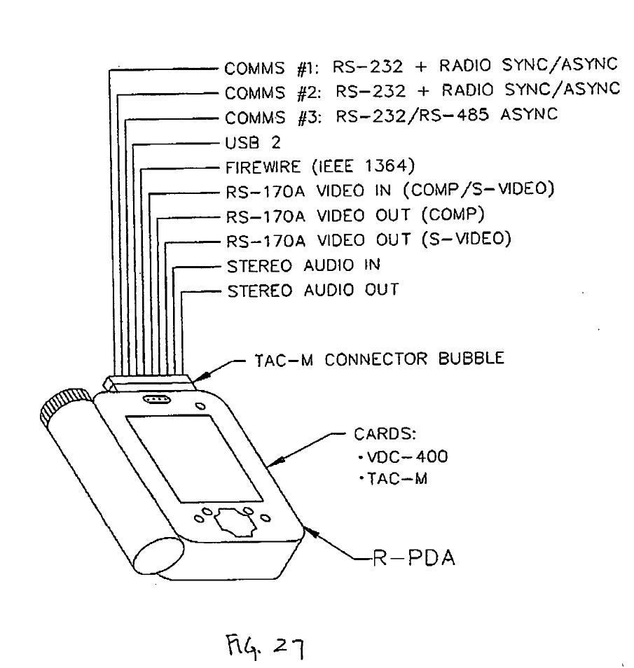

3.1 TAC-M PCMCIA Card Architecture (FIG. 26)

The Tac-M PCMCIA Card Block Diagram is presented below:

3.1.1 PCMCIA Card Housing and Connector
Industry PCMCIA Type II

3.1.2 Primary Gate Array
PCMCIA Host Interface
Gate Array Power Management
External Power Management Control Pins
USART Engines for Three Serial Communications Channels
Glue Logic for all system elements

3.1.3 Communications Drivers and Crypto/Radio Controls
Channel #1 (Radio or Sensor)
   RS-232
   Synchronous or Asynchronous
   PTT and DDMC Crypto/Radio Control
Channel #2 (Radio or Sensor)
   RS-232
   Synchronous or Asynchronous
   PTT and DDMC Crypto/Radio Control
Channel #2 (Radio or Sensor)
   RS-232 or
   RS-485 (for SLP)
   Asynchronous

3.1.4 USB Controller Chip
USB-2 Standards
Master or Slave

3.1.5 Firewire Interface Chip
IEEE 1394 Standards

3.1.6 Video CODEC Chip
MPEG-1, MPEG-2 and MPEG-4 Full-Motion Video Compression Standards
Frame Grabber Function
MEG still Compression
Audio Stream Insertion

3.1.7 Audio CODEC Chip
Stereo Audio AID
Stereo Audio D/A
Industry Compression Standards

3.1.8 Analog Video Decoder
Composite or S-Video Input Processing
NTSC or PAL Decoding
Video A to D

3.1.9 Analog Video Encoder
Video D to A
NTSC or PAL Encoding
Composite Output (simultaneous)
S-Video Output (simultaneous)

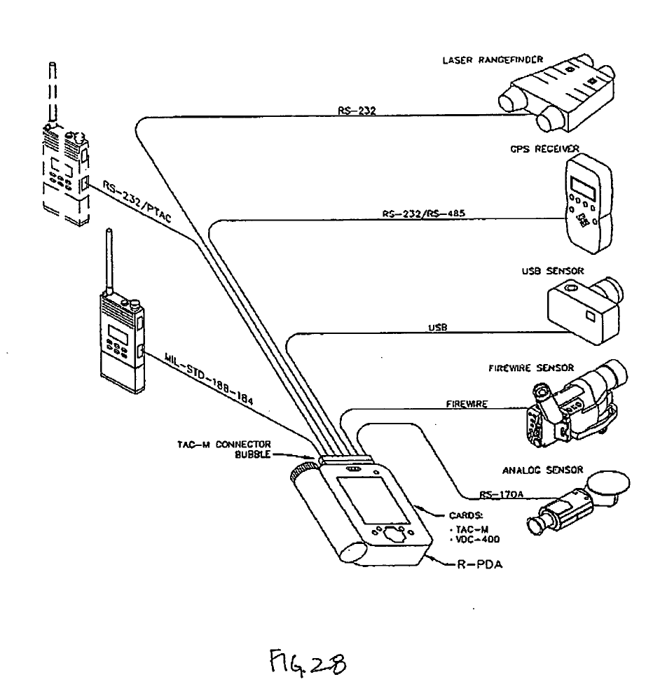

3.2 R-PDA with Embedded TAC-M Card (FIG. 27)

The R-PDA utilized in the DRSTA program will be equipped with an embedded TAC-M card. The extensive multimedia 110 port complement requires a connector with a large number pins for the various signals. The connector to be utilized is a splash-proof 50 ping type that is mounted in a Connector Bubble on the top side of the R-PDA housing. The MIL-STD-188-884 signals from the embedded VDC-400 card will also be brought out of that connector.

Cable assemblies of various configurations will be made that support specific communications and sensor devices.

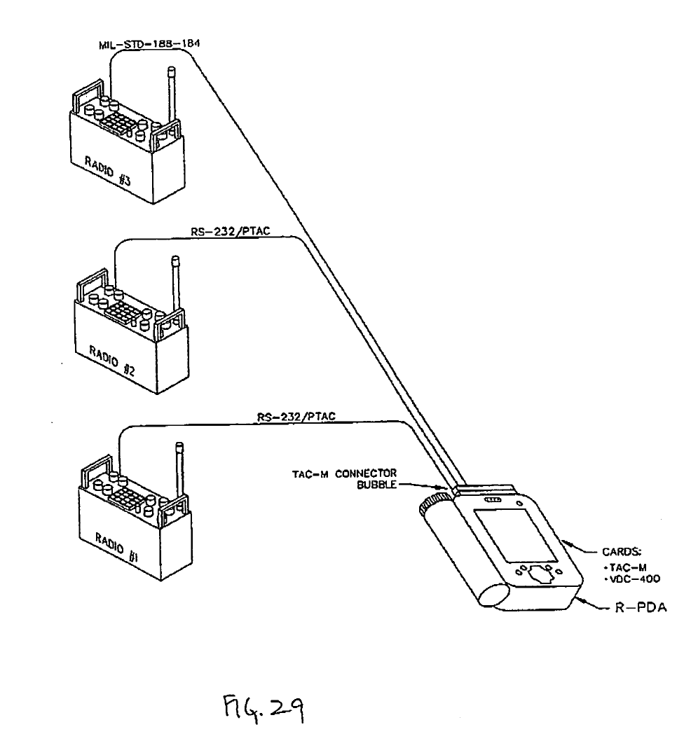

3.3 Surveillance Site with TAC-M/R-PDA (FIG. 28)

The TAC-M and VDC-400 cards embedded in the R-PDA provides an unmatched comprehensive radio and sensor capability to the Scout! Forward Observer in a very small package. Note that each type of sensor element has an independent bus available to it at all times. Also, more than one Radio is supported (up to three) in the Surveillance Site application.

TAC-M is the only solution known by the Contractor that can provide the required complement of DRSTA sensor ports simultaneously. In fact, it provides more ports and types of ports than are listed in the requirements, thus providing growth potential and best value.

3.4 Hide Site with TAC-M/R-PDA

Although the primary advantage of the TAC-M Card is realized at the Surveillance Site, the Hide Site can also greatly benefit from the use of the capability.

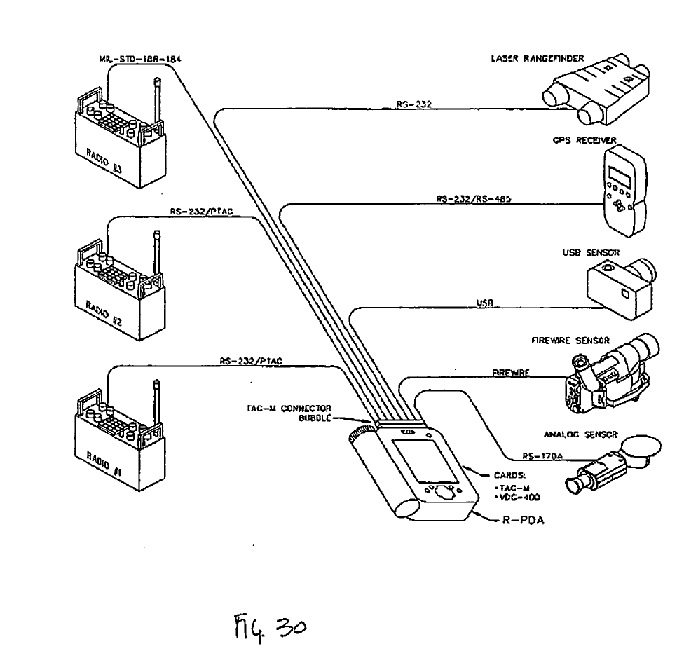

3.4.1 Increased Radio Capability (FIG. 29)

A R-PDA outfitted with the TAC-M card and a VDC-400 card can support up to three “PTT/DDMC” style radio sets, and an additional fourth RS-232 interfaced radio set if needed.

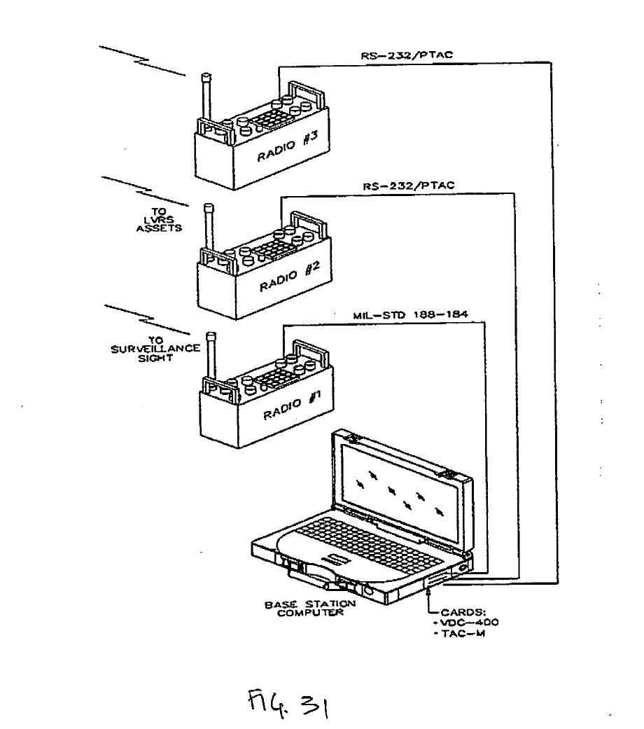

3.4.2 Increased Sensor Capability (FIG. 30)

A R-PDA outfitted with the TAC-M card and a VDC-400 card can not only support up to four simultaneous radio sessions, it can provide simultaneous complement of sensor 110 ports to allow a Scout/Observer to bring a Digital Camera, Analog or Digital Camcorder or other RS-170A, USB or Firewire video/image device with storage back to the Hide-Site for data transfer. The image or video data can then be captured, processed, stored and/or tactically communicated from the Hide Site.

3.5 Hide Site with Tac-M/R-PDA

The TAC-M PCMCIA Card does not have to be operated in an embedded platform, it can also be utilized in a standard Laptop PCMCIA socket in a conventional manner to increase the capability of the DRSTA/LVRS Base Station.

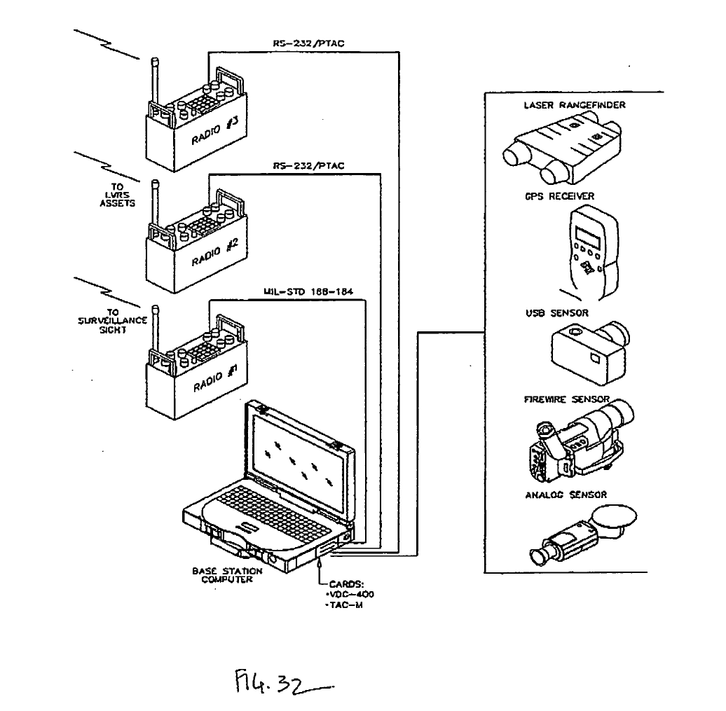

3.5.1 Increased Radio Capability (FIG. 31)

A R-PDA outfitted with the TAC-M card and a VDC-400 card can support up to three “PTT/DDMC” style radio sets, and an additional fourth RS-232 interfaced radio set if needed. This can be highly valuable to the mission. For example, with the TAC-M card the Base Station can simultaneously talk to the DRSTA Surveillance Site, the LVRS assets, the PRISM I FTI Aviation Assets, and one additional Data Net.

3.5.2 Increased Sensor Capability (FIG. 32)

DRSTA/LVRS Base Station outfitted with the TAC-M card and a VDC-400 card can, in addition to supporting up to four simultaneous radio sessions, provide a simultaneous complement of sensor I/O ports allowing input of any RS-170A video source, Digital Camera, Analog or Digital Camcorder, USB or Firewire video/image material into the net via the Base Station. This can enhance the mission by allowing targeting information or other video media stored surveillance information to be transmitted to Headquarters, peer nodes, aircraft or Scouts/Observers via the TAC-M card.

4.0 Software Technical Architecture

The foundation for the DRSTA software development has been laid in the Windows CE based tactical communications core that PhotoTelesis Corporation has built over the last three years. This core is currently being utilized in at least four major Military Programs featuring Windows CE platforms embedded in Hand Carried Scout/Forward Observer systems and various Aviation Platforms. These include FTI-II, PRISM-IDM, PRISM-VTR and LVRS. This product family has been in real-word deployment on the Windows CE platform for two years.

The basic building blocks that will build the DRSTA system are listed in the following summary:
Core
   The PhotoTelesis fielded and proven PRISM Foundation (done)
   DRSTA Application Layer, PhotoTelesis (development item)
User Interface, with content from:
   Prism Foundation,
   JVMF Message Handling in the PFED Program
   Image Manipulation in PhotoTelesis ICE.
   Communications Control in ViaSat
   MIL-STD-188-184 Communications Status—PhotoTelesis ICE
Protocols
   MIL-STD-188-184 from ViaSat (done)
   PLGR from PhotoTelesis LVRS Program (done)
   MELIOS from PhotoTelesis LVRS Program (done)
   Leica Vector (Viper) from PhotoTelesis MARS program (done)
   Serial Channel, USB and Firewire from industry (done, will port)
Image Manipulation & NITFS
   PhotoTelesis ICE (done, will port)
Drivers
   VDC-400 as jointly developed by ViaSat and PhotoTelesis (done)
   Stand-Alone Cards
      USB Card, PhotoTelesis (development item)
      Frame Grabber Card (done—from Industry, several candidates)
      Firewire Card (currently not needed)
   TAC-M Card, PhotoTelesis (development item)
   iPAQ PDA Keyboard, Display, PCMCIA controller, SeriaWSB (done, HP)

4.1 Specific Software Development Tasks

4.1.1 Windows CE-Based SIW Application

PhotoTelesis will draw on its considerable experience developing Windows CE embedded systems to create a multi-purpose application that will meet the needs of both the Surveillance and Hide Site computers.

A subset of the features implemented in the popular ICE^{T} application software package. Functionality for Inbox, Outbox, and Address List will be ported. In addition, the user interface for dynamic configuration of communications channel(s) and review/annotation of both captured and received images and messages will be implemented. User interface for configuration of both analog and digital imagery capture will be provided for the user.

4.1.2 Two Independent MIL-STD-188-184 Channels

The ViaSat VDC-400 is currently used in the Military MicroRIT (MMR) for the Army LVRS Program. The same core technology that provides for dual, independent, channel interface for the MMR will be used in the DRSTA to incorporate two (2) independent MIL-STD-188-184 channels for the Surveillance/Hide Site Computer. The system will accomplish this using two (2) VDC-400 Personal Data Controllers (PDCs).

A modified version of the proven MMIt device driver will be used to support both data controllers. The VDC-400A Driver for Windows CE was ported by PhotoTelesis under special arrangement with ViaSat Corporation. Therefore any required modifications for DRSTA by PhotoTelesis are low risk.

4.1.3 Interfacing the PLGR and PLGR-II

The intricate interface to the Portable Lightweight GPS Receiver (PLGR) was successfully developed for the LVRS MMR. This interface will be seamlessly integrated and extended to the PLGR-II during the DRSTA project.

This interface will allow the user of the Surveillance/Hide Site computer to accurately determine their position anywhere in the world. This, combined with a laser range finder, will provide real-time accurate positional data of targets of interest.

4.1.4 Interfacing with the MELIOS and VIPER Laser Range Finder(s)

The Sensor Link Protocol (SLP) for interface to the Digital MELIOS was developed by PhotoTelesis for the MMR project. The NEMA interface for the Leica family of GPS products was developed for the Army Special Ops MARS program. PhotoTelesis will adapt the interfaces to DRSTA to provide timely and accurate positional data of any target of interest within the range of the LRF.

4.1.5 Video Sensor Interface

The PhotoTelesis PRISM, FTI-II, and MMR currently support a full NTSC/PAL Video Sensor Interface under Windows CE. The PhotoTelesis ICE supports USB image functions under Windows NT and Windows 2000. The USB capability will be ported to Windows CE in a consistent manner to the NTSCIPAL software. No known drivers exist for USB Masters under Windows CE. Therefore, PhotoTelesis will implement USB Master interface drivers consistent with the RS-170A composite image capture driver.

4.1.6 JVMF Message Interface

PhotoTelesis has incorporated message formats in its ICE and MMR software. The DRSTA requirements specify additional JVMF reports which have to be implemented. To support DRSTA, PhotoTelesis will add the twelve (12) requested JVMF messages to its library. PFED user interface models will be considered for this implementation to preserve consistency with fielded Army systems. This task is considered very low risk.

4.1.7 Image Manipulation

The PhotoTelesis ICE application is currently certified with the JITC at C LEVEL-3 V2.1. Image manipulation techniques have been developed for both the ICE software and the software for the Scout/Forward Observer in the MMR system. Using this background of information and code, PhotoTelesis will develop a simple to use interface that will allow the user to define the orientation of the image, identify targets, and reference landmarks considering both destructive, and non-destructive techniques of annotation of digital imagery. In addition, simple free form text entry and editing will be available for both annotation and association with the digital image.

What is claimed is:

1. A multimedia input system for a handheld device, comprising:
a. a gateway interface;
b. a plurality of discrete input sources generating a plurality of unique input signals and capable of communicating with the gateway interface;
C. a converter for converting the each of the plurality of input signals into a signal format acceptable by the handheld device.

2. The system of claim 1, wherein the gateway interface is a hub.

3. The system of claim 1, wherein the gateway interface is a router.

4. The system of claim 1, wherein the gateway interface is adapted for selectively receiving each of the unique input signals at a single port.
